(19) United States
(12) Patent Application Publication
(10) Pub. No.: US 2026/0287182 A1
(43) Pub. Date: Sep. 24, 2026

(54) RECONFIGURABLE COOKING APPLIANCE

(71) Applicant: Sunbeam Products, Inc., Atlanta, GA (US)

(72) Inventors: Oliver A. Daemi, Bramhall (GB); Christian Philip Keogh, Manchester (GB); Mick Cunningham, Manchester (GB); Zachary Adam Hafner, Kalamazoo, MI (US); Corey R. Barnes, Grand Rapids, MI (US); James F. Caruso, Wilmette, IL (US); Wyatt Cline, Atlanta, GA (US)

(73) Assignee: Sunbeam Products, Inc., Atlanta, GA (US)

(21) Appl. No.: 19/685,757

(22) Filed: May 22, 2026

Related U.S. Application Data
(63) Continuation of application No. PCT/US2025/052198, filed on Oct. 23, 2025.
(60) Provisional application No. 63/712,291, filed on Oct. 25, 2024.
(60) Provisional application No. 63/780,129, filed on Mar. 28, 2025.

(51) Int. Cl. F24C 15/16; F24C 15/02; F24C 15/32

(52) U.S. Cl. CPC F24C 15/16; F24C 15/02; F24C 15/322

(57) ABSTRACT

A cooking appliance that can be used in multiple orientations is provided. Specifically, the cooking appliance can be used in a horizontal orientation and a vertical orientation. The cooking appliance includes accessory mounting supports/channels on all internal surfaces that allow accessories to be removably installed when the cooking appliance is in either orientation. The cooking appliance also includes multiple heating and air flow control systems that can be operated individually to control airflow and temperature within the cooking appliance. The cooking appliance can be used in a single chamber configuration or a multi-chamber configuration with the use of a divider. The cooking appliance includes a display that can detect the change in orientation and a controller that can enable and disable cooking modes based on the appliance orientation.

### CROSS-REFERENCES TO RELATED APPLICATIONS

This application is a continuation of International Application No. PCT/US25/52198, filed Oct. 23, 2025, and titled “Reconfigurable Cooking Appliance,” which claims the benefit of U.S. Provisional Patent Application No. 63/712,291, filed on Oct. 25, 2024, and titled “Reconfigurable Cooking Appliance,” and U.S. Provisional Patent Application No. 63/780,129, filed on Mar. 28, 2025, and titled “Reconfigurable Cooking Appliance,” the disclosures of which are incorporated by reference herein in their entirety for all purposes.

### TECHNICAL FIELD

The present disclosure relates generally to cooking appliances. Specifically, the embodiments of the present disclosure are related to reconfigurable cooking appliance that can be used in a plurality of orientations or configuration, such as both horizontal and vertical orientations.

### BACKGROUND

Conventional cooking appliances are designed to be used in a single orientation, either horizontal or vertical. For example, an air fryer is usually placed in a horizontal orientation and operable in that single orientation. Stacked cooking appliances exist, but they also can only be used in a single orientation. This reduces the versatility of these cooking appliances, and a user may need to buy multiple cooking appliances if they want to cook different types of foods and/or use multiple cooking modes.

There is a need in the industry for a versatile cooking appliance that can be used in multiple orientations and that supports multiple cooking modes based on the orientation and addresses other related, and unrelated issues, in the relevant art.

### SUMMARY

Embodiments of the present disclosure disclose a cooking appliance that may include a housing that defines a chamber. The chamber may have a first surface, a second surface, a third surface and a fourth surface. The cooking appliance may also include a first set of supports disposed on the first surface, a second set of supports disposed on the second surface, a third set of supports disposed on the third surface, and a fourth set of supports disposed on the fourth surface. In an embodiment, the first surface may be orthogonal to the second surface, the second surface may be orthogonal to the third surface, and the third surface may be orthogonal to the fourth surface. The cooking appliance may further include a plurality of heating elements and a plurality of air flow control systems. In an embodiment, each of the plurality of airflow control systems may further include a fan, a sensor configured to detect an orientation of the cooking appliance, an air flow director coupled to the fan, and a motor coupled to the air flow director. In an embodiment, the air flow director is operable to control the flow of air within the cooking appliance. The motor may be further configured to receive an input from the sensor and operate the air flow director based on the input. The cooking appliance may also include a processor, one or more sensors coupled to the processor, and a display device coupled to the processor. The processor may be operable to receive an input from the one or more sensors, determine an orientation of the cooking appliance based on the input, and enable a first set of cooking modes based on the orientation. In an embodiment, the cooking appliance can be configured in a first orientation and a second orientation. In the first orientation, a first set of cooking modes are enabled while a second set of cooking modes are disabled and in the second orientation, the second set of cooking modes are enabled while the first set of cooking modes are disabled. The cooking appliance may include a support feature having a first portion that is disposed over a first external surface of the housing and a second portion that is disposed over a second external surface of the housing. In an embodiment, the first external surface may be orthogonal to the second external surface. The cooking appliance may also include a plurality of doors that are combinable to operate as a single door and each of the plurality of doors is moveable about a plurality of axes. In an embodiment, the first surface of the cooking appliance is opposite to the third surface, and the second surface is opposite to the fourth surface. Further, the first set of supports are identical to the third set of supports and second set of supports are identical to the fourth set of supports. The cooking appliance may further include a first set of accessories and a second set of accessories, and wherein the first set of accessories is configured for use when the cooking appliance is placed in a first orientation, and the second set of accessories is configured for use when the cooking appliance is placed in a second orientation.

Other embodiments of the present disclosure provide a method of operating a cooking appliance. The method may include a processor of the cooking appliance receiving first data from one or more sensors of the cooking appliance at a first time and determining, based on the first data, that the cooking appliance is in a first orientation of a plurality of orientations. The method may further include determining a first set of cooking modes based on the first orientation and displaying the first set of cooking modes on a display of the cooking appliance. The method may also include receiving an input indicative of selection of a first cooking mode from the first set of cooking modes and operating the cooking appliance based on the first cooking mode. In an embodiment, the method may further include receiving second data from the one or more sensors at a second time and determining, based on the second data, that the cooking appliance is in a second orientation of the plurality of orientations. The method may then include determining a second set of cooking modes associated with the second orientation, enabling the second set of cooking modes, and disabling the first set of cooking modes. In an embodiment, the first orientation is a horizontal orientation, and the second orientation is a vertical orientation. The method may further include displaying first content in a first format when the cooking appliance is in the first orientation and displaying second content in a second format when the cooking appliance is in the second orientation.

Other embodiments of the present disclosure provide a cooking appliance that may include a heating system, an airflow control system, a housing that defines a chamber, a plurality of air flow channels, and a plurality of doors coupled to the housing. The chamber may include four surfaces and each of the four surfaces may have a plurality of supports disposed thereon, and each of the plurality of supports may be configured to accept a removable accessory. In addition, the airflow control system may include a rotating air flow director configured to selectively block one or more of the plurality of air flow channels. In an embodiment, the cooking appliance may further include a first powered accessory. The powered accessory may be configured to be supported by a first pair of supports of the plurality of supports and the first powered accessory may receive electrical power from the cooking appliance. In an embodiment, the plurality of supports may further include a first set of supports disposed on a first surface, a second set of supports disposed on a second surface, a third set of supports disposed on a third surface, and a fourth set of supports disposed on a fourth surface. The first surface may be orthogonal to the second surface, the second surface may be orthogonal to the third surface, and the third surface may be orthogonal to the fourth surface. In an embodiment, the cooking appliance may further include a support feature coupled to two or more external surfaces of the housing. The cooking appliance may be operable in a first orientation and a second orientation that is orthogonal to the first orientation. The cooking appliance may also include a display device coupled to the housing. In this instance, the cooking appliance may be configured to enable a first set of cooking modes in the first orientation and receive a first input associated with the first set of cooking modes. In the second orientation the cooking appliance may enable a second set of cooking modes, disable the first set of cooking modes, and receive a second input, via the display device, associated with the second set of cooking modes. In another embodiment, the airflow control system of the cooking appliance may include two or more fans, and the two or more fans may be individually controllable.

In yet other embodiments, a cooking appliance is provided that may include a cooking chamber that may have a plurality of airflow channels defined within the cooking chamber and an air flow director that may be configured to selectively direct airflow along one or more of the plurality of airflow channels based on an orientation of the cooking appliance. The cooking appliance may be operable in a first orientation and a second orientation, and the first orientation may be orthogonal to the second orientation. The plurality of air flow channels of the cooking appliance may include a first airflow channel and a second airflow channel. In the first orientation, the airflow director may direct the airflow toward the first airflow channel and in the second orientation, the airflow director may direct the airflow toward the second airflow channel. In a particular embodiment, the plurality of airflow channels may be defined within an interior surface of the cooking chamber. The cooking appliance may further include a fan and a heating element, and the fan and the heating element may be located towards a rear end of the cooking appliance. The cooking appliance may further include a first chamber and a second chamber. The first chamber may be positioned adjacent to the second chamber, and the cooking appliance may further include a divider, the divider being configured to be placed between the first chamber and the second chamber. In an instance, the divider may be removably couplable to the cooking appliance. The airflow director may be further configured to selectively direct the airflow along the one or more of the plurality of airflow channels based on a configuration of the cooking appliance and the configuration may include selection of a cooking recipe or selection of a type of food being cooked.

Embodiments of the present disclosure provide a method performed by a cooking appliance. The method may include determining an orientation of the cooking appliance, selecting one or more of a plurality of airflow channels of the cooking appliance, and operating an airflow director to direct airflow toward the selected one or more airflow channels. The method may further include detecting selection of a cooking recipe and operating the airflow director further based on the cooking recipe. In an instance, the orientation may include a first orientation and a second orientation, and the plurality of airflow channels may include a first airflow channel and a second airflow channel. The method may further include detecting, at a first time, that the cooking appliance is placed in the first orientation, and operating the airflow director to direct airflow toward the first airflow channel. The method may further include detecting, at a second time, that the cooking appliance is placed in the second orientation and operating the airflow director to direct airflow toward the second airflow channel. In an embodiment, operating the airflow director may be further based on a cooking mode of the cooking appliance. The airflow director may be coupled to a motor, and the method may further include receiving data from a sensor of the cooking appliance, determining the orientation of the cooking appliance based on the data, and operating the motor based on the data.

Other embodiments of the present disclosure provide a cooking appliance that may include one or more cooking chambers, one or more airflow directors in fluid communication with the one or more cooking chambers, and one or more airflow channels in fluid communication with the one or more airflow channels directors. The cooking appliance may also include a fan, a motor coupled to the fan, and a heating element coupled to the fan. The motor may be configured to operate the fan based on an orientation of the cooking chamber and the one or more airflow directors may be configured to selectively direct airflow from the fan to the one or more airflow channels. The one or more cooking chambers may include a first cooking chamber and a second cooking chamber, the one or more airflow directors may include a first airflow director associated with the first cooking chamber and a second airflow director associated with the second cooking chamber, and the one or more airflow channels may include a first airflow channel and a second airflow channel. The cooking appliance may be configured to operate in a first orientation and a second orientation, and in the first orientation, the first airflow director may be configured to direct airflow toward the first airflow channel, and the second airflow director may be configured to direct the airflow toward the second airflow channel.

### BRIEF DESCRIPTION OF THE DRAWINGS

FIG. 1 illustrates a cooking appliance in accordance with the principles of the present disclosure.

FIG. 2A illustrates a partial perspective view the cooking appliance in accordance with the principles of the present disclosure.

FIG. 2B illustrates a partial back view of the cooking appliance in a vertical orientation in accordance with the principles of the present disclosure.

FIG. 2C illustrates a partial view of the cooking appliance in the horizontal orientation in accordance with the principles of the present disclosure.

FIGS. 3A and 3B illustrate the operation of the display of the cooking appliance in accordance with the principles of the present disclosure.

FIG. 3C illustrates a display connected to a hinge of the cooking appliance in accordance with the principles of the present disclosure.

FIG. 3D illustrates the mechanical rotation of a display attached to the cooking appliance in accordance with the principles of the present disclosure.

FIGS. 4A-4C illustrate a method for changing the orientation of the cooking appliance in accordance with the principles of the present disclosure.

FIGS. 4D and 4E illustrate two embodiments of the support feature in accordance with the principles of the present disclosure.

FIGS. 4F and 4G illustrate a cooking appliance with sliding doors in accordance with the principles of the present disclosure.

FIG. 5 illustrates a partial back side view of the cooking appliance in accordance with the principles of the present disclosure.

FIGS. 6A and 6B illustrate the operation of the door of the cooking appliance in accordance with the principles of the present disclosure.

FIGS. 7A-7C illustrates use of accessories in the cooking appliance in the various orientations of the cooking appliance in accordance with the principles of the present disclosure.

FIGS. 8A-8E illustrate various configurations of the cooking appliance in a vertical orientation in accordance with the principles of the present disclosure.

FIGS. 9A-9E illustrate various configurations of the cooking appliance in a horizontal orientation in accordance with the principles of the present disclosure.

FIGS. 10A and 10B illustrate a partial sectional view of the heating and air flow control assembly and the internal chamber of the housing in accordance with the principles of the present disclosure.

FIG. 10C illustrates the rotating disc of the airflow control system in accordance with the principles of the present disclosure.

FIG. 10D illustrates the air flow path in the cooking appliance in accordance with the principles of the present disclosure.

FIG. 11 illustrates a flow chart of a process for operating the cooking appliance in accordance with the principles of the present disclosure.

FIG. 12 is a functional block diagram of a cooking appliance in accordance with the principles of the present disclosure.

FIGS. 13A-13D illustrate different views of a cooking appliance in accordance with the principles of the present disclosure.

FIGS. 14A and 14B illustrate cross-sectional views of the cooking appliance in accordance with the principles of the present disclosure.

FIGS. 15A-15C illustrate details of the structure of the air flow channel, the air flow director, and the fan and their relative orientations in accordance with the principles of the present disclosure.

FIG. 15D illustrates an embodiment in which a movable mechanical control is used to control air flow in accordance with the principles of the present disclosure.

FIGS. 16A-16D illustrate some examples of the air flow patterns within the cooking appliance in accordance with the principles of this disclosure.

FIGS. 17A-17C illustrate various views of a portion of an air flow channel in accordance with the principles of the present disclosure.

FIG. 17D illustrates an alternate embodiment for the air flow within the cooking appliance in accordance with the principles of the present disclosure.

FIG. 18 illustrates details of an air flow channel in accordance with the principles of the present disclosure.

FIG. 19 illustrates a flow diagram of a process for managing air flow within a cooking appliance in accordance with the principles of the present disclosure.

FIG. 20 illustrates an accessory that may enable control of air flow in accordance with the principles of the present disclosure.

FIG. 21 illustrates another accessory in accordance with the principles of the present disclosure.

FIG. 22A illustrates a reconfigurable cooking appliance in accordance with the principles of the present disclosure.

FIG. 22B illustrates a partial view of a reconfigurable cooking appliance in accordance with the principles of the present disclosure.

FIG. 23 illustrates details of the airflow control mechanism of the reconfigurable cooking appliance in accordance with the principles of the present disclosure.

FIG. 24 illustrates a partial front view of the airflow control mechanism in accordance with the principles of the present disclosure.

FIG. 25 illustrates internal details of the airflow control mechanism in accordance with the principles of the present disclosure.

FIGS. 26A and 26B illustrate details of the center divider of a reconfigurable cooking appliance in accordance with the principles of the present disclosure.

FIGS. 26C-26E illustrate various views of the center divider in accordance with the principles of the present disclosure.

FIG. 26F illustrates details of the alignment of center divider and a back surface of the cooking chamber in accordance with the principles of the present disclosure.

FIGS. 27A-27C illustrate details of the door locking and unlocking mechanism of a reconfigurable cooking appliance in accordance with the principles of the present disclosure.

FIG. 28 illustrates the sliding member of the door locking and unlocking mechanism in accordance with the principles of the present disclosure.

FIG. 29 illustrates an automated baffle movement assembly in accordance with other principles of the present disclosure.

FIG. 30 illustrates a schematic of a reconfigurable cooking appliance in accordance with yet other the principles of the present disclosure.

FIG. 31 illustrates a schematic of a reconfigurable cooking appliance having airflow channels on all surfaces in accordance with the principles of the present disclosure.

FIG. 32 illustrates a schematic of a reconfigurable cooking appliance having multiple airflow channels and air flow director positions FIG. 30 illustrates a schematic of a reconfigurable cooking appliance in accordance with the principles of the present disclosure.

FIG. 33 is a schematic illustrating operation of the reconfigurable cooking appliance in a vertical orientation in accordance with the principles of the present disclosure.

FIGS. 34A-34C illustrate use of static icons in an user interface of a reconfigurable cooking appliance in accordance with the principles of the present disclosure.

FIG. 35 is a schematic illustrating use of a reconfigurable cooking appliance in a vertical orientation and multiple chamber configuration in accordance with the principles of the present disclosure.

FIG. 36 is a schematic illustrating use of a reconfigurable cooking appliance in a vertical orientation and multiple chamber configuration in accordance with other principles of the present disclosure.

FIGS. 37A-37D illustrate operation of the user interface of a reconfigurable cooking appliance in multiple orientations in accordance with the principles of the present disclosure.

FIGS. 38A-38B illustrate a schematic of a reconfigurable cooking appliance having an auto-adjusting user interface in accordance with other principles of the present disclosure.

The drawings are provided for purposes of illustration only and merely depict example embodiments of the disclosure. The drawings are provided to facilitate understanding of the disclosure and shall not be deemed to limit the breadth, scope, or applicability of the disclosure. The use of the same reference numerals indicates similar, but not necessarily the same or identical components. Different reference numerals may be used to identify similar components. Various embodiments may utilize elements or components other than those illustrated in the drawings, and some elements and/or components may not be present in various embodiments. The use of singular terminology to describe a component or element may, depending on the context, encompass a plural number of such components or elements and vice versa.

### DETAILED DESCRIPTION

The various embodiments of a reconfigurable cooking appliance described herein advantageously allow the cooking appliance to be used either in a horizontal orientation or a vertical orientation with multiple cooking modes. The embodiments are described in detail herein to enable one of ordinary skill in the art to practice the reconfigurable cooking appliance, although it is to be understood that other embodiments may be utilized and that logical changes may be made without departing from the scope of the disclosure. Reference is made herein to the accompanying drawings illustrating some embodiments of the disclosure, in which use of the same reference numerals indicates similar or identical items. Throughout the disclosure, depending on the context, singular and plural terminology may be used interchangeably.

The meanings of the terms used herein will be apparent to one of ordinary skill in the art or will become apparent to one of ordinary skill in the art upon review of the detailed description when taken in conjunction with the several drawings and the appended claims.

Embodiments of the present disclosure include a cooking appliance that includes a housing that defines a chamber. The chamber has a first surface, a second surface, a third surface and a fourth surface. A first set of supports are disposed on the first surface, a second set of supports are disposed on the second surface, a third set of supports are disposed on the third surface, and a fourth set of supports are disposed on the fourth surface. The first surface is orthogonal to the second surface, the second surface is orthogonal to the third surface, and the third surface is orthogonal to the fourth surface.

Other embodiments of the present disclosure provide a method of operating a cooking appliance. The method includes the cooking appliance receiving at a first time, first data from one or more sensors of the cooking appliance. The cooking appliance then determines, based on the first data, that the cooking appliance is in a first orientation of a plurality of orientations. The cooking appliance then determines a first set of cooking modes based on the first orientation and displays the first set of cooking modes. The cooking appliance then receives an input indicative of selection of a first cooking mode from the first set of cooking modes and operates based on the first cooking mode.

In yet another embodiment, a cooking appliance is provided that includes a heating system, an airflow control system, a housing that defines a chamber, and a plurality of doors coupled to the housing. The chamber includes four surfaces and each of the four surfaces has a plurality of supports disposed thereon and each of the plurality of supports on each of the four surfaces configured to accept a removable accessory, The airflow control system includes a baffle having a plurality of openings and a rotating disc configured to selectively block one or more of the plurality of openings.

The present disclosure provides details on a specific type of cooking appliance, but one skilled in the art will realize that other types of cooking appliances may also be manufactured using the systems and methods provided in this disclosure.

FIG. 1 illustrates a cooking appliance 10 in accordance with the principles of the present disclosure. The cooking appliance 10 supports various cooking modes such as air fry, air crisp, crip, toast bake, rotisserie, grill, roast, steam, dehydrate, reheat, etc. or other suitable cooking modes, including, without limitation, additional conductive or convection cooking modes. The cooking appliance 10 has a housing 12 that defines an internal chamber 16. The internal chamber 16 can accept various types of accessories and food items to be cooked. The cooking appliance 10 also includes one or more doors 14 attached to one surface of the housing 12. The doors 14 are configured to operate along multiple axes. In one embodiment, the doors may be hinged to the housing 12 such that the doors 14 swing from left to right or from right to left when the cooking appliance is placed in a vertical orientation. In another embodiment, when the cooking appliance 10 is placed in a horizontal orientation, the doors 14 are attached to the housing 12 such that the doors are either hinged to the bottom side of the housing 12 or to the top side of the housing 12. In this embodiment, the doors 14 may open from the top side of the housing 12 towards the bottom side of the housing 12 as illustrated in FIG. 1 or the doors may open from the bottom side of the housing 12 towards the top side of the housing 12. In one embodiment, the two doors 14 may be locked together to operate as a single door.

The cooking appliance 10 also includes a support feature 18 that enables the cooking appliance to be placed in the horizontal or the vertical orientations. A user may rotate the cooking appliance 10 using a portion of the support feature 18 to move the cooking appliance 10 between the vertical and the horizontal orientation and vice versa. In an embodiment, the support feature 18 may be located on and/or span two or more external surfaces of the housing 12. In an embodiment, the support feature 18 may be made using a pressure absorbing material. In other embodiments, the support feature may include one or more feet, rollers, sliders, or the like. The support feature further can include one or more dampening portions or mechanisms to facilitate transitioning or movement of the cooking appliance between orientations, e.g., between the vertical and horizontal orientation. The cooking appliance 10 may also include a display/control unit 20 attached to one surface of the housing 12. The display 20 may be a movable, e.g., a flip-out, display that rests within a recessed cavity of the housing 12 when the cooking appliance 10 is not in use. The cooking appliance 10 may also include heating and air flow control assembly (not shown) that enables the various cooking modes supported by the cooking appliance 10. Details of the air flow control are described below.

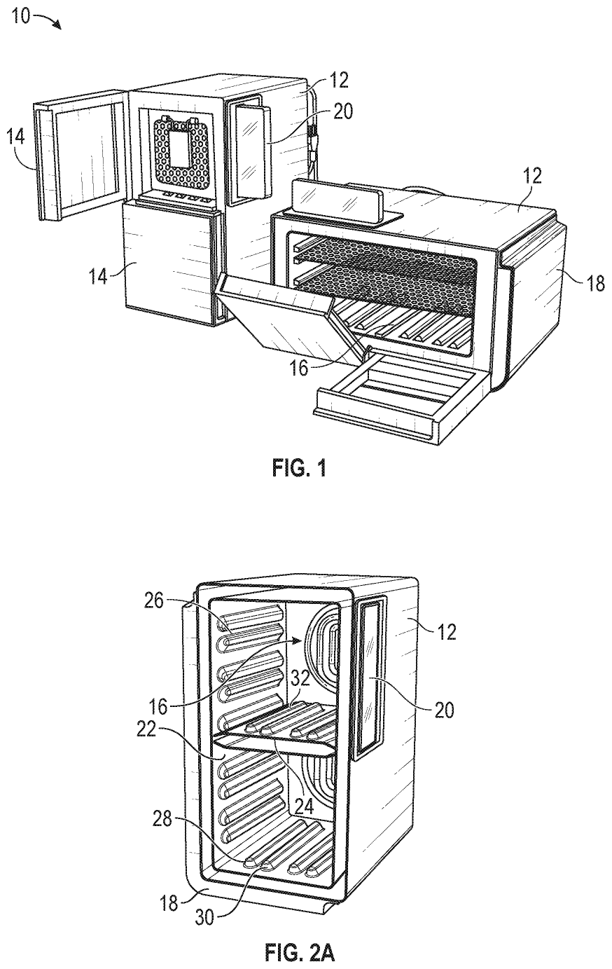

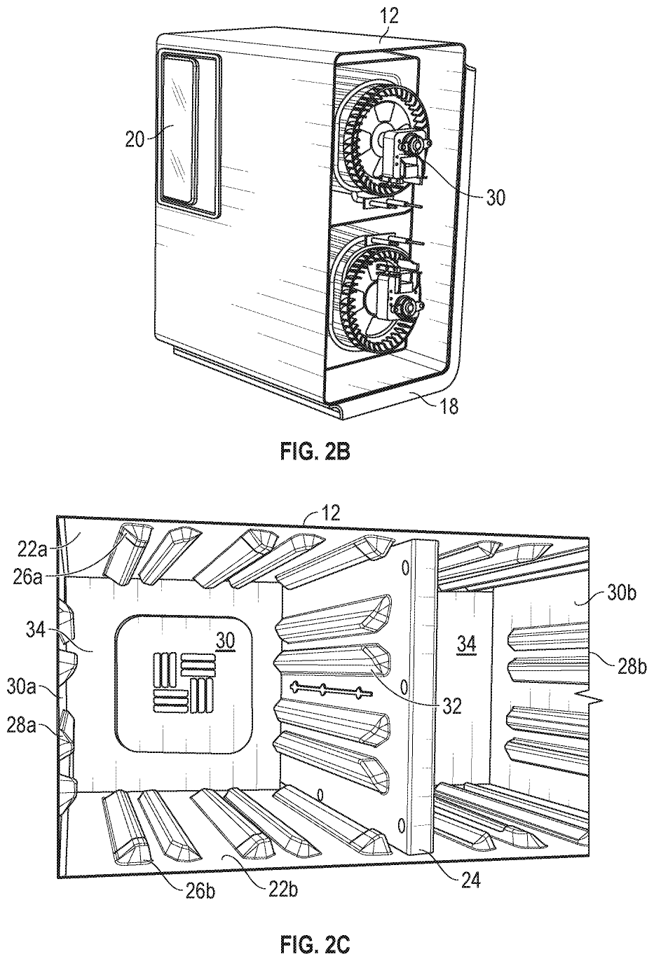

FIG. 2A illustrates a partial perspective view the cooking appliance in accordance with the principles of the present disclosure. As noted above, the housing 12 defines the internal chamber 16. The internal chamber 16 can be configured to be used as a single chamber for cooking or can be divided or separated into at least two individual chambers by using a removable divider 24, though the chamber can be separated into additional chambers, e.g., three or more without departing from the scope of the present disclosure. The internal chamber 16 has at least four surfaces. Two surfaces 22 are parallel to each other and are disposed along two opposing walls of the internal chamber 16. The other two surfaces 30 are parallel to each other and are disposed along two other opposing walls of the internal chamber 16. Each of the surfaces 22 is orthogonal to each of the other surfaces 30, though the surfaces can be otherwise angled in relation to each other without departing from the scope of the present disclosure. The two surfaces 22 and the other two surfaces 30 together define a rectangular shape. Each of the two surfaces 22 has a first set of supports, or channels 26 located along the entire length of the surface 22. Similarly, each of the other two surfaces 30 have a second set of supports or channels 28 located along the entire length of the surface 30. The divider 24 may also have multiple supports or channels 32 disposed on two opposing surfaces of the divider 24. The first set of supports 26 and the second set of supports 28 are configured to accept various accessories like a tray, a basket, a powered accessory, etc. When the divider 24 is used, the supports 32 on the divider 24 are also configured to accept one or more accessories.

FIG. 2B illustrates a partial back view of the cooking appliance in a vertical orientation in accordance with the principles of the present disclosure. The cooking appliance includes one or more heating and air flow control assemblies 30 located at the rear of the housing 12. When the cooking appliance is configured for multi-chamber operation, each of the heating and air flow control assembly 30 may be operated individually and independently to serve a single chamber of the multiple chambers. In other embodiments, when the cooking appliance is used in a single-chamber configuration, the two heating and air flow control assemblies 30 may operate in conjunction to serve the single chamber. Details of the air flow control assembly 30 are provided below. The heating and air flow control assembly may include a heating element coupled with a fan unit and air flow control mechanism to optimize the air flow within the internal chamber 16. The cooking appliance further can include other venting mechanisms or air flow paths that are reconfigurable based on the orientation of the cooking appliance. FIG. 2C illustrates another partial view of the cooking appliance in the horizontal orientation according to an embodiment of the present disclosure. As can be seen, the divider 24 is structured such that it can be mounted in a set of two of the first set of supports 26. Use of the divider 24 effectively divides, splits, or separates the internal chamber 16 of the cooking appliance into individual cooking chambers 34 (e.g., two chambers 34 as illustrated). As noted above, in this configuration, each heating and air flow control assembly 30 can now serve the individual chamber 34. In one embodiment, the first set of supports 26, the second of supports 32 and the set of supports 32 all have identical design and dimensions. In an embodiment, a first number of the first set of supports 26 may be larger than a second number of the second set of supports 28. In another embodiment, a third number of the set of supports 32 is less than both the first number and the second number.

As described above, the first set of supports 26 are disposed over two opposing surfaces of the internal chamber 16. For instance, a set of supports 26a may be disposed over a first surface 22a of the internal chamber 16 and a set of supports 26b may be disposed over a second opposing surface 22b of the internal chamber 16. Similarly, a set of supports 28a may be disposed over a third surface 30a of the internal chamber 16 and set of supports 28b may be disposed over an opposing fourth surface 30a of the internal chamber 16. The supports are located such that each support 26a is directly opposite a support 26b. Thus, one of the supports 26a and one of the supports 26b together form an opposing pair of supports into which an accessory can be placed. Similarly, one of supports 28a and one of supports 38b together form an opposing pair of supports into which an accessory may be placed. It is to be noted that even though supports 26, 28, and 32 are illustrated as having a specific structure, any other structure for these supports may be used based on common knowledge in the art.

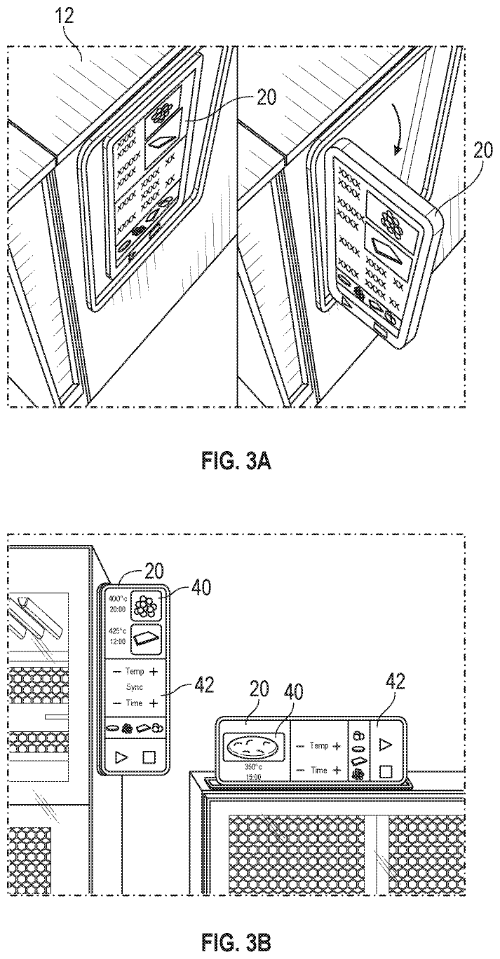

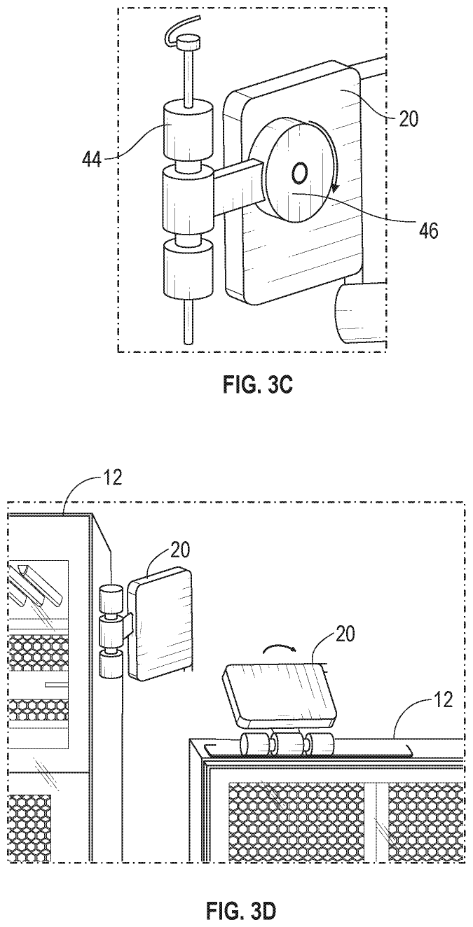

FIGS. 3A and 3B illustrate the operation of the display 20 of the cooking appliance in accordance with the principles of the present disclosure. The display 20 can be an LCD, LED-type, or other suitable touch screen display that can display a mix of graphics 40 and text 42. In some embodiments, tactile controls may be embedded in the display 20. The display (or the cooking appliance) may include one or more sensors that can detect the tilting or the orientation of the cooking appliance. For example, the sensors may include force balance sensors, solid-state MEMS devices, or fluid-filled electrolytic or capacitive sensors. The sensor further can include pressure sensor or mechanical sensors that can detect when the cooking appliance is in the vertical or horizontal orientations. When the cooking appliance is placed in the horizontal or vertical orientation, the sensor(s) can detect the orientation of the cooking appliance and provide an input to the controller of the cooking appliance. The controller may then change the orientation of the content being displayed on the display device 20. In an embodiment, when the cooking appliance is not being used, the display 20 can be folded and placed within a recessed region of the housing 12. When the cooking appliance is to be used, the display 20 can be flipped out or otherwise removed from the recessed region. In a particular embodiment, the display 20 can function as a power on/off switch for the cooking appliance. For example, the housing 12 may include a micro-switch embedded in it. The action of flipping open the display 20 may activate that micro-switch which can then turn on the cooking appliance. Similarly, folding the display down into the recessed region can activate the micro-switch again to turn off power to the cooking appliance.

In an embodiment, the displayed content on the display device 20 may change based on the orientation of the cooking appliance. When the cooking device is in the vertical orientation, the graphics 40 and text 42 may be displayed in a first arrangement in which the graphics may be displayed towards a top side of the display 20 and the text and other controls may be placed towards the bottom side of the display 20. In addition, the overall space occupied by the graphics 40 and text 42 may be adjusted to fit the width of the display 20 as illustrated on the left-hand side of FIG. 3B. When the cooking appliance is placed in the horizontal orientation, the location of the graphics 40 and the text 42 may be changed to span the length of the display 20, as illustrated on the right-hand side of FIG. 3B. In an embodiment, the display 20 may be fixed such that once the display 20 is flipped out, it remains in that state until it is folded back into the recessed region. In other embodiments, the display 20 may mechanically rotate between a first orientation and a second orientation based on the orientation of the cooking appliance. The first orientation may be orthogonal to the second orientation. In this instance, the display may be coupled to a motor that can move the display between the first orientation and the second orientation. In other embodiments, the display 20 may be coupled to a hinge 44 that enables the display 20 to rotate around an axis in a swivel motion, as illustrated in FIG. 3C. The hinge 44 may be coupled to the housing 12 of the cooking appliance. The hinge 44 may include a ball joint 46 and the display 20 can rotate in a 90 degree arc around the ball joint 46 when the cooking appliance is moved from the horizontal to the vertical orientation and vice versa. FIG. 3C shows that the display may have multiple degrees of freedom. In this regard, the display may rotate or otherwise move about an axis passing through the hinge 44 and further may rotate or otherwise move about an axis orthogonal to the ball joint 46 (e.g., as indicated by the rotational arrow in FIG. 3C). In yet another embodiment, the display may physically rotate from a first position to a second position based on the orientation of the cooking appliance. The physical rotation of the display may be in the form of swivel action, a clockwise and/or anticlockwise rotation, or the like. FIG. 3D illustrates the physical rotation of the display 20 attached to the hinge 44 and the ball joint 46 when the cooking appliance is in the vertical orientation and horizontal orientation. As the cooking appliance is moved between the vertical and horizontal orientations, the display 20 rotates around the ball joint 46 to correctly orient itself to align with the cooking appliance.

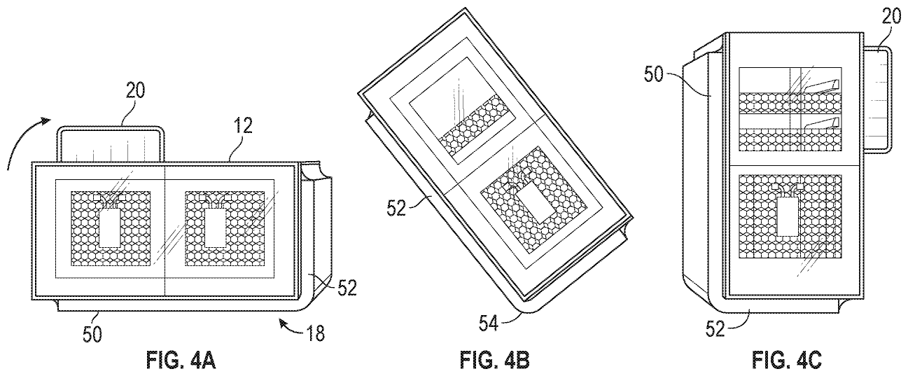

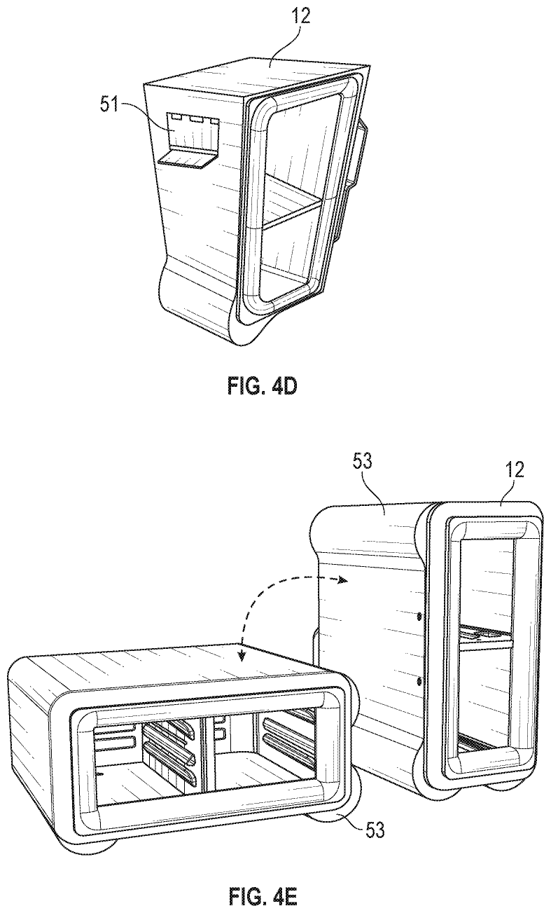

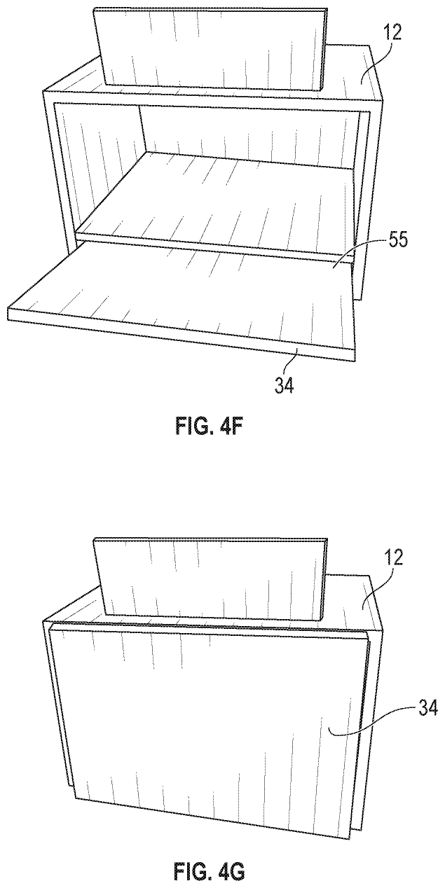

FIGS. 4A-4C illustrate a method for changing the orientation of the cooking appliance in accordance with the principles of the present disclosure. The cooking appliance has a tilt support feature 18 that is attached to the housing 12, as described above. In an embodiment, the support feature 18 may have a first portion 50 attached to a first external surface of the housing 12 and a second portion 52 attached to a second external surface of the housing 12. The first portion 50 and the second portion 52 form one continuous structure that defines the support feature 18. The first portion 50 is orthogonal to the second portion 52. When the cooking appliance is in a horizontal orientation, the first portion 50 of the support feature 18 is in contact with the surface on which the cooking appliance is placed, as illustrated in FIG. 4A. When the user wants to change the orientation of the cooking appliance, the user can rotate the cooking appliance in a clock-wise direction around the point portion 54 of the support feature 18, as illustrated in FIG. 4B. The point portion 54 is curved to facilitate the rotation of the cooking appliance. The cooking appliance can be rotated until the second portion 52 of the support feature 18 is in contact with the surface on which the cooking appliance is placed. This completes the orientation change and now the cooking appliance is in the vertical orientation as illustrated in FIG. 4C. In other embodiments, various other mechanisms for facilitating the change in orientation of the cooking appliance can be implemented. For example, one or more feet may be added to the housing 12 such that when the cooking appliance is being rotated to change its orientation the feet either extend or retract to all easy change in the orientation. In another instance, one or more ergonomic grab points may be provided on one or more external surfaces of the housing 12. These ergonomic grab-points may have a tactile material that helps with gripping the cooking appliance. In yet other embodiment, rubber feet may be provided with dampers to allow smooth movement between the two orientations. In another embodiment, one or more rollers may be coupled to one or more external surfaces of the housing 12 to allow the cooking appliance to be moved on a surface and/or change between the two orientations. In an embodiment, any accessories present within the cooking appliance may be removed prior to changing the orientation of the cooking appliance. For changing the orientation of the cooking appliance from the vertical to the horizontal orientation, a reverse process may be followed where the cooking appliance is rotated in an anti-clockwise direction around the pivot point portion 54.

FIGS. 4D and 4E illustrate two embodiments of the support feature 18 in accordance with the principles of the present disclosure. FIG. 4D illustrates a cooking appliance having a support feature 51 that is implemented as a flip-out dampener or foot. In the vertical orientation, the flip out dampener 51 remains in a closed or retraced position and is resting withing a recessed region of the housing 12 (e.g., such that feature 51 does not extend from the housing 51). When the cooking appliance is moved into the horizontal orientation, the flip-out foot 51 is move out of (e.g., automatically rotated) the recessed region with the motion of the cooking appliance and gravity and provides dampening or support for placing the cooking appliance in the horizontal orientation. In additional, or alternative embodiments, the appliance can include a plurality of dampening features 51 positioned along a surface of the housing 12 (e.g., at, near, or adjacent and upper corner of the housing when the appliance is in the vertical orientation). In one embodiment, the dampening features 51 can include retractable portions, such as retractable feet, retractable cylindrical portions, or other suitable retractable portions that can move into and out of (or retract into and extend from) corresponding openings in the housing (or openings in portions or structures attached to the housing). The dampening features can include one or more biasing or dampening members or materials considered to help dampen or control movement of the appliance as it is moved from the vertical to horizontal orientations. In the regard, to move the appliance from the vertical to the horizontal orientation, a user can start to tilt the appliance towards the horizontal orientation (e.g., by applying a force to the appliance). As the user tilts the appliance towards the horizontal orientation, a bottom corner of the appliance in the vertical orientation may slide along or move parallel to the surface upon which the appliance sits, such as a countertop (the “appliance's supporting surface”), until the dampening features 51 (or feature 51) each contract or otherwise engage the appliance's supporting surfaces. Then, the dampening features 51 (or feature 51) can control or help to control the remainder of the movement of the appliance to the horizontal orientation. In some embodiments, a user will be able to release the appliance and allow to dampening features 51 (or feature 51) to control the movement of the appliance once engaged with the supporting surface. In addition, the dampening features may help to prevent slamming or dropping of the appliance when the appliance is moved to the horizontal orientation. Further, in embodiments, the dampening features 51 (or feature 51) can include or be in communication with the sensors to indicate that the appliance is in the horizontal or vertical orientation. The dampening features 51 (or feature 51) further can include one or more motors, mechanical actuators, biasing members, etc. to facilitate movement to extended and retracted positions. FIG. 4E illustrates another embodiment of the support feature 18 implemented as one or more bump structures 53. The bump structures 53 may be placed at the top and bottom of a surface of the housing 12. When the cooking appliance is moved from the vertical to the horizontal orientation, the bump structures 53 contact the surface on which the cooking appliance is placed thereby providing the necessary support for the cooking appliance. As illustrated, one of the bump structures is included in FIG. 4D; however, this bump structure can be or include one or more wheels, sliders, etc., without departing from the present disclosure.

FIGS. 4G and 4E illustrate a cooking appliance with sliding doors in accordance with the principles of the present disclosure. As mentioned above, the cooking appliance can be placed in the vertical orientation or a horizontal orientation. When the cooking appliance is moved from one orientation to another, it is important to secure the moving parts of the cooking appliance, such as the doors, so that these parts don't rattle during the motion. In an embodiment, the cooking appliance may include an opening 55. The opening 55 can be configured to accept the one or more doors 34 of the cooking appliance. Just prior to changing the orientation of the cooking appliance, the door 34 may be tucked into the opening 55 and thereby secured. The cooking appliance may then be rotated into the desired orientation. Once the cooking appliance has been placed in the desired orientation, the door 34 may be pulled out of the opening 55 and moved to cover the internal chamber of the cooking appliance. In other embodiments, there may be a stop or lock mechanism that holds the door(s) 34 in place while the cooking appliance is being moved from one orientation to another. While a single door 34 is illustrated, it is to be noted that the same feature can be implemented in a cooking appliance that has two or more doors, without departing from the scope of the present disclosure.

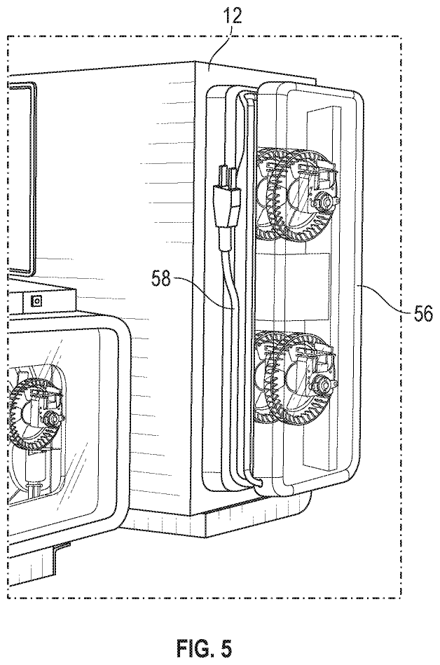

FIG. 5 illustrates a partial back side view of the cooking appliance 10 in accordance with the principles of the present disclosure. In this embodiment, the housing 12 includes a translucent cover 56 attached to the backside of the housing 12. The translucent cover 56 is disposed over and covers the heating and air flow control assembly/assemblies. The translucent cover 56 also includes a cord management area 58 that can store the power cord that is attached to the cooking appliance 10.

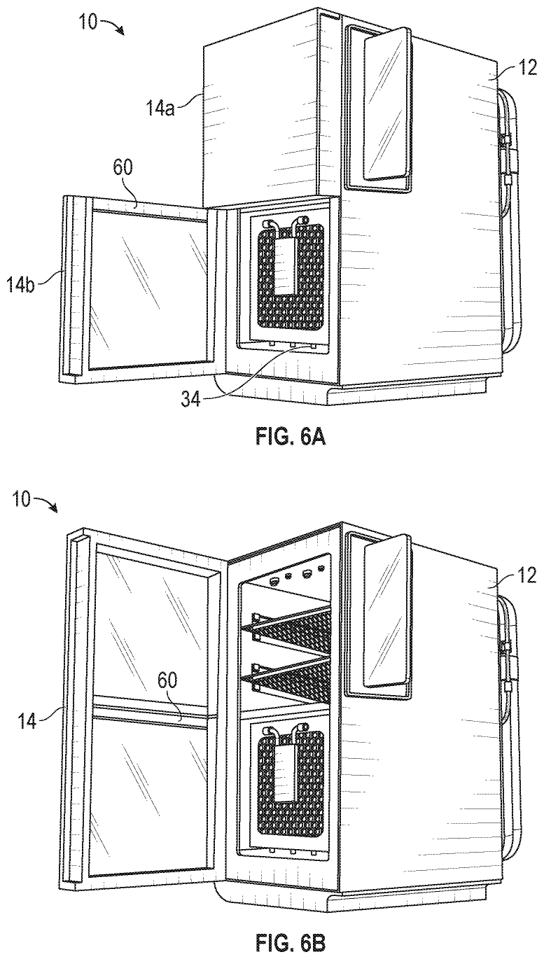

FIGS. 6A and 6B illustrate the operation of the door 14 of the cooking appliance 10 in accordance with the principles of the present disclosure. The cooking appliance 10 may have two individual doors 14a and 14b. Each of the doors 14a and 14b is individually operable to open and close. When the divider 24 is used to split the internal chamber 16 of the cooking appliance into two individual chambers 34 (as illustrated in FIG. 2C), each of the doors 14a and 14b operate to close each of the individual chambers 34. Each of the doors 14a and 14b can open and close about a plurality of axes. For example, each of the doors 14a and 14b can open and close along a first axis and a second axis. In an embodiment, the first axis is non-parallel to the second axis. In another embodiment, the first axis is orthogonal to the second axis. The operation of the doors 14a and 14b around a particular axis may depend on the orientation of the cooking appliance 10. For instance, when the cooking appliance is in the horizontal orientation, the doors 14a and 14b may operate about the first axis and when the cooking appliance is in the vertical orientation, the doors 14a and 14b may operate about the second axis. Thus, the operation of the doors 14a and 14b is dependent on the orientation of the cooking appliance 10. In certain embodiments, the two doors 14a and 14b may be connected together to operate a single door 14 as illustrated in FIG. 6B. The two doors 14a and 14b may be locked or otherwise secured at the midportion 60 to form a single door 14 that covers the entire internal chamber 16 of the cooking appliance 10.

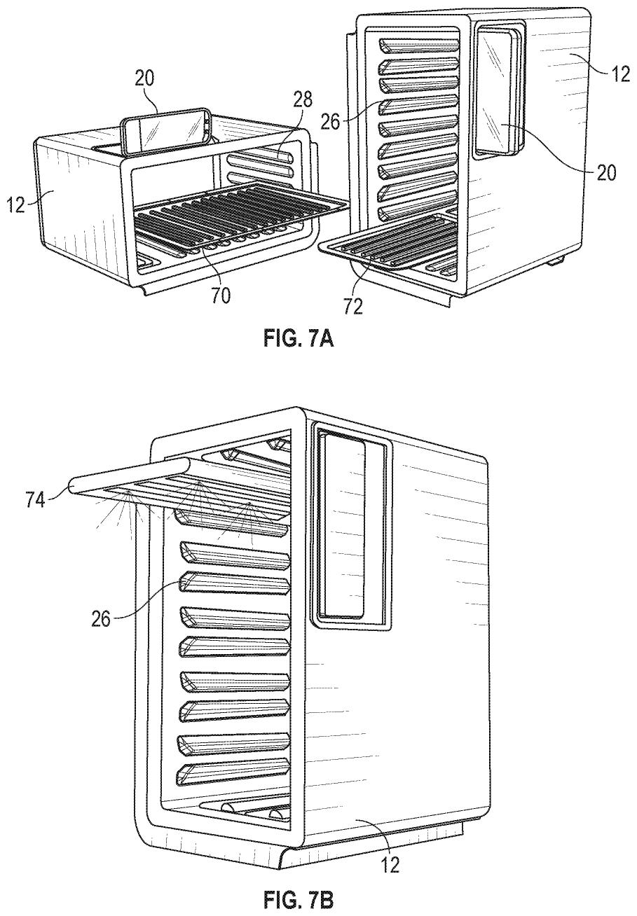

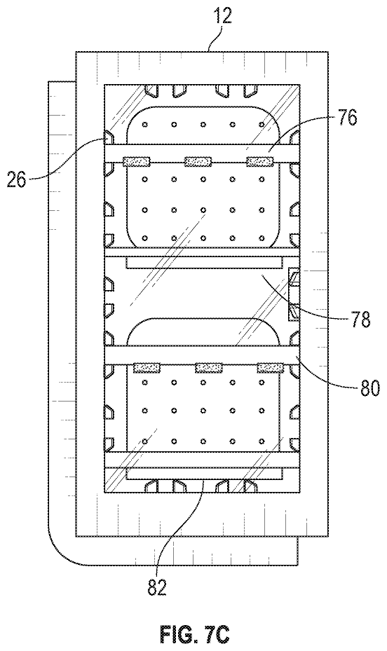

FIGS. 7A-7C illustrates use of accessories in the cooking appliance in the various orientations of the cooking appliance in accordance with the principles of the present disclosure. When the cooking appliance is placed in the horizontal orientation, one or more trays or shelfs 70 can be placed inside the cooking appliance. Each tray or shelf 70 can be placed within a pair of opposing supports 28 that are located on two opposing surfaces of the inner chamber 16 of the housing 12. When the appliance is in a vertical orientation, a different shelf/tray 72 may be placed within the chamber 16 and supported by a pair of opposing supports 26. In an embodiment, the size of the tray or shelf 70 may be different than a size of the tray or shelf 72. In some embodiments, a powered accessory 74 may be removably placed inside the cooking appliance supported either by support pair 28 or support pair 26 depending on the orientation of the cooking appliance. The powered accessory 74 may be a crisper that may be placed over the food being cooked to add a bit of crunch to the food. The powered accessory 74 may have one or more electrical connectors that mate with corresponding electrical connectors attached to the housing 12 of the cooking appliance. The cooking appliance may supply power to the powered accessory 74 via these electrical connectors. The power accessory 74 may have one or more heating elements 20. In some embodiments, multiple powered accessories 76 and 80 and multiple non-powered accessories 78 and 82 may be placed within the cooking appliance at the same time. Since both the powered accessories 76 and 80 and the non-powered accessories 78 and 82 are designed to be placed with the support pairs 26 or 28, the location of the powered and a non-powered accessories may be easily interchanged based on the cooking mode and food being cooked. In other embodiments, the accessories can include a single basket, a plurality of baskets, clam shell baskets, perforated fry baskets, baskets with removable handles, or racks (e.g., one rack, dual racks, 5 or more racks, etc.). According to embodiments of the present application, powered or non-powered accessories can include racks (such as multilayer, skewer, or dehydrating racks), trays (such as baking, mesh, or crisper trays), baskets (such as mesh or perforated baskets of varying depths and configurations), pans (such as baking, grill, or roasting pans); grates (such as grill or broiling grates), rotisserie components (such as spits, forks, or cages); and other suitable powered or non-powered accessories, including dehydrating inserts, steaming trays, or rotating baskets.

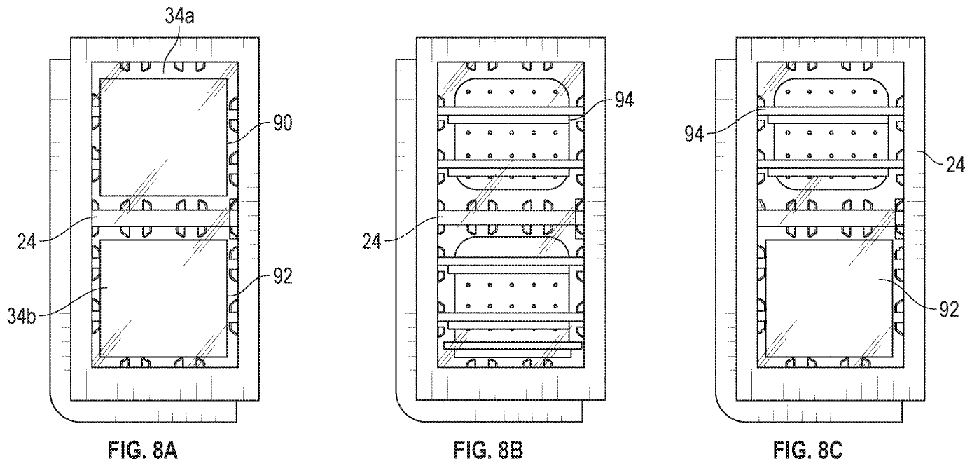

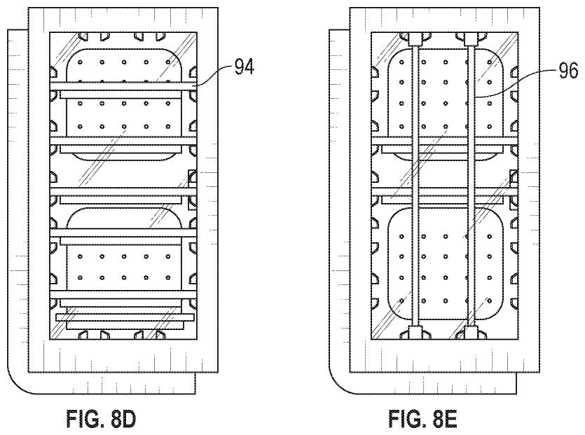

FIGS. 8A-8E illustrate various configurations of the cooking appliance in a vertical orientation in accordance with the principles of the present disclosure. FIG. 8A illustrates a configuration in which the cooking appliance is divided into two chambers by placing the removable divider 24 within one of the support pairs. The removable divider 24 splits or separates the internal chamber of the cooking appliance into a plurality of individual chambers, e.g., chambers 34a and 34b. Although the two chambers 34a and 34b are shown as being equal in size, that is not necessary and the two chambers 34a and 34b can be different sizes depending on the placement of the divider 24 (or additional dividers). A first basket accessory 90 may be placed in the upper chamber 34a and a second basket accessory 92 may be placed in the lower chamber 34b. Each of the upper chamber 34a and the lower chamber 34b may be individually operated to cook the food placed in the respective baskets. FIG. 8B illustrates a configuration where multiple non-powered and/or powered accessories 94 are placed in each of the upper chamber 34a and the lower chamber 34b. FIG. 8C illustrated a configuration in which one or more powered or non-powered accessories 94 are placed in the upper chamber 34a and a basket accessory 92 is placed in the lower chamber 34b. FIGS. 8D and 8E illustrate a configuration where the entire cooking appliance is used in a single chamber configuration without the use of any divider. In this configuration, multiple powered and/or non-powered accessories 94 can be placed within the single chamber separated by a distance and supported by a pair of supports. In some embodiments, one or more skewers 96 may be placed vertically in the single chamber to allow for cooking in that mode.

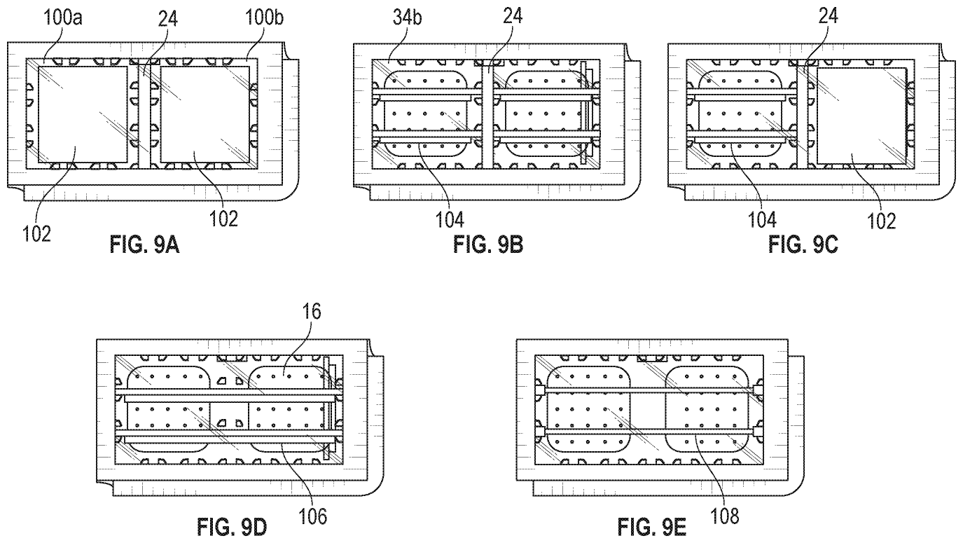

FIGS. 9A-9E illustrate various configurations of the cooking appliance in a horizontal orientation in accordance with the principles of the present disclosure. As illustrated in FIG. 9A, the cooking appliance can be split into two individual chambers 100a and 100b by placing the divider 24 in any of a pair of opposing supports. Although the two chambers 100a and 100b are shown as being equal in size, that is not necessary and the two chambers 100a and 100b can be different sizes depending on the placement of the divider 24. Two basket accessories 102 can be placed each with the chambers 100a and 100b. In another embodiment, a number of non-powered or powered accessories 104 can be placed within each of the chamber 100a and 100b. In yet another embodiment, a combination of powered or non-powered accessories and a basket accessory can be placed in the chambers 100a and 100b as illustrated in FIG. 9C. FIGS. 9D and 9E illustrate configurations of the cooking appliance when the cooking appliance is used in a single or large chamber configuration without the divider 24. In these embodiments, larger and different powered or non-powered accessories 106 may be placed withing the single chamber 16 of the cooking appliance. In another embodiment, one or more skewers 108 may be arranged to facilitate horizontal cooking of food such as in a rotisserie mode.

In an embodiment, the cooking appliance 100 may include a first set of accessories that have a first configuration. The cooking appliance 100 may also include a second set of accessories that may have a second configuration. In an embodiment, the first configuration may be different than the second configuration. Moreover, in certain embodiments, the first set of accessories may be used when the cooking appliance is used in a first or vertical orientation and the second set of accessories may be used when the cooking appliance is used in a second or horizontal orientation. Thus, there may be dedicated set of accessories that may be used based on the orientation of the cooking appliance 100. In other embodiments, the first set of accessories and the second set of accessories may be not be interchangeable and may only be used along with a specific orientation of the cooking appliance 100. In other words, the first set of accessories may be not be used when the cooking appliance is in the second orientation and the second set of accessories may be not be used when the cooking appliance is in the first orientation.

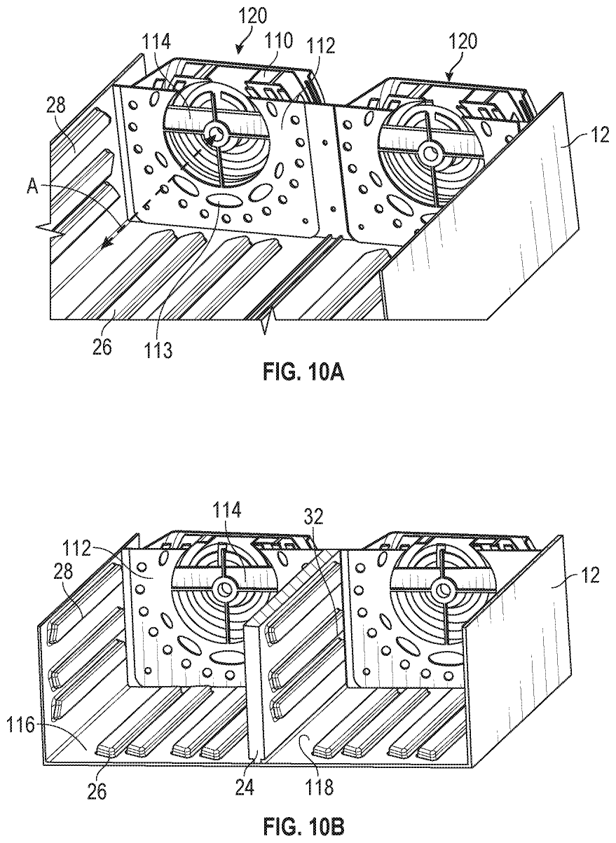

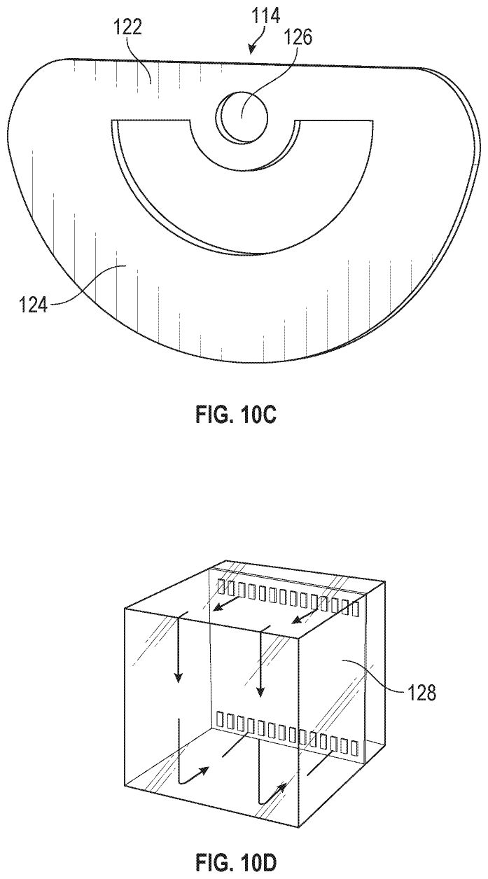

In order to optimize or speed up the cooking time and ensure that the food is cooked evenly and thoroughly, it is beneficial to have accurate control over the temperature inside the cooking chamber. In both the single chamber configuration and the dual/multiple chamber configuration, proper temperature control needs to be maintained in order for the cooking appliance to function optimally. In one embodiment, in the entire single chamber configuration, the entire chamber can be considered as a single entity and the air allowed to flow equally in all directions within the chamber. In a dual chamber configuration, each heat and air flow control assembly of the cooking appliance may all equal air flow in all directions within each of the two chambers. Both these approaches can be used for cooking. However, in both the above instances, allowing equal flow of air in all directions may reduce the efficiency of the cooking appliance. A controlled and directional flow of air may be useful in enhancing the efficiency of the cooking appliance. FIGS. 10A-10E illustrates a mechanism to control the amount and direction of air flow within the cooking appliance both in the single chamber configuration and the dual chamber configuration according to an embodiment of the present disclosure.

FIGS. 10A and 10B illustrate a partial sectional view of the heating and air flow control assembly and the internal chamber of the housing 12 in accordance with the principles of the present disclosure. In an embodiment, the cooking appliance may include at least two heating and air flow control assemblies 120. Each heating and air flow control assembly 120 may include a heating element (not shown), a fan or an impeller 110, a rotating disc 114, and fixed baffle 112. The fixed baffle 112 may have one or more openings 113 to allow air to pass through them. The openings 113 may include openings having different sizes and/or shapes. The openings 113 may not be evenly distributed across the surface of the baffle 112 or may have a pattern of distribution. The rotating disc 114 may rotate around an axis “A”. The rotating disc 114 selectively blocks one or more of the openings 114 thereby controlling the amount and direction of the air flow within the chamber. In a dual chamber configuration where the divider 24 is used to split the internal chambers into two individual chambers 116 and 118, each heating and air flow control assembly 120 control the air flow within a respective one of the two chambers 116 and 118. In operation, depending on the cooking mode, the cooking appliance configuration (e.g., single chamber or dual chamber), the orientation of the cooking appliance (e.g., horizontal or vertical), and the required temperature to be maintained within the respective chamber, the individual fans are operated to direct the amount and direction of air flow within the chamber. In one embodiment, the rotating disc 114 is rotated about the axis A to selectively block or unblock the openings 113 to allow or block air flow within the chambers. The fan 110 of each of the heating and air flow control assemblies 120 can be individually controlled. For example, one fan 110 may ‘on’ while the other fan 110 may be ‘off’. One fan 110 may be operated at a first speed while the other fan may be operated concurrently a second speed that is different than the first speed. In other instances, both the fans 110 can be operated at the same speed. In some instances, the duty cycle for each fan 110 may be varied individually or collectively. In other instances, the fans 110 may be controlled based on the accessories present in the cooking appliance and/or the type of food being cooked. In yet another instance, one fan 110 may be operated in a clockwise direction while the other fan 110 may be operated in an anti-clockwise direction.

In an embodiment, the rotating disc 114 may be weighted such that the rotating disc 114 automatically rotates around the axis A when the orientation of the cooking appliance is changed from vertical to horizontal and vice versa. In addition, the supports 26 and/or 28 may include features that may be used to channel or divert the air in a particular direction within the chamber(s). In the instance where the divider 24 is used, the supports 32 on the divider 24 may also include features that aid in channeling or diverting air within the individual chambers 116 and 118. FIG. 10C illustrates the rotating disc 114 according to an embodiment of the present disclosure. The rotating disc 114 is planar and semi-circular in shape and includes a first portion 122 and a second portion 124. The second portion 124 is larger than the first portion 122. The rotating disc 114 is connected to the fan 110 at the pivot location 126 and is configured to rotate around the axis A that passes through the pivot point 126. The second portion 124 of the rotating disc is configured to block one or more openings 113 of the fixed baffle 112. FIG. 10D illustrates the air flow path 128 when using the rotating disc 114 and the fixed baffle 112. As can be seen during operation, the second portion 124 of the rotating disc 114 blocks multiple openings 113 of the fixed baffle 112 at the lower side of the fixed baffle 112 thereby forcing more air to flow into the top side of the chamber compared to the bottom side of the chamber. This allows for the heated air to flow over the food being cooked and thereby increases the efficiency of the cooking appliance and ensures that the food is cooked evenly. The rotating disc 114 may be controlled throughput the recipe time based on the cooking mode and heat requirements to allow more or less air to flow from the bottom of the chamber. In other embodiments, the rotating disc 114 and the baffle 112 may operate to distribute the air in and around the chamber.

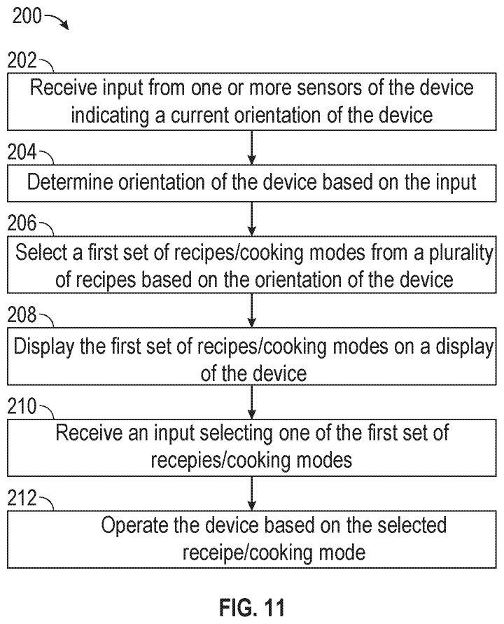

As described above, the content displayed on the display device is controlled based on the cooking mode and the orientation of the cooking appliance 10. For example, when the cooking appliance in the horizontal mode, only a first of recipes and/or cooking modes may be enabled while other cooking modes may be disabled. For example, the cooking mode for baking a pizza may only be enabled when the cooking appliance is in the horizontal orientation and disabled when the cooking appliance is in the vertical orientation. Similarly, when the cooking appliance is in the vertical orientation only a specific set of recipes/cooking modes may be enabled that can be used for cooking in the vertical orientation. FIG. 11 is a flow chart for a process 200 for operating a cooking appliance in accordance with the principles of the present disclosure. At step 202, the cooking appliance may receive an input from one or more of its sensors indicating a current orientation of the cooking appliance. Based on the input received, the cooking appliance determines its current orientation at step 204. For example, the current orientation may be horizontal or vertical. Thereafter, at step 206, the cooking appliance determines and enables a set of cooking modes associated with the determined orientation. Once those cooking modes are determined and enabled, the cooking appliance may display a list of available cooking modes on a display device associated with the cooking appliance, at step 208. At step 210, the cooking appliance may receive an indication of selection of a cooking mode from the list of cooking modes displayed in step 208. Based on the selected cooking mode, the cooking appliance may operate in the selected cooking mode at step 212.

In some embodiments, the cooking appliance may selectively enable or present a cooking mode, a cooking workflow including one or more cooking modes, and/or one or more recipes based on the orientation of the cooking appliance. A cooking workflow may include a sequence of cooking modes to be performed by the cooking appliance. The recipes may be associated with the type of food being cooked. In some embodiments, a cooking workflow may include a preset sequence of cooking modes, such as bake, broil, crisp, etc. The cooking appliance may display these cooking modes, cooking workflows, and/or recipes on the display of the cooking device based on the orientation of the cooking device. In an embodiment, the cooking device may communicate information about the cooking modes, cooking workflow, and/or the recipes to a user device.

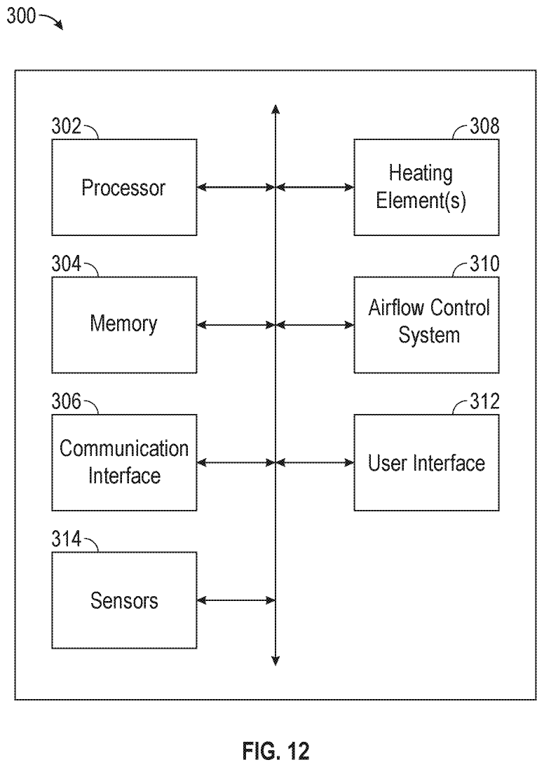

FIG. 12 is a functional block diagram of a cooking appliance 300 in accordance with the principles of the present disclosure. The cooking appliance 300 can be implemented as the cooking appliance 10 described above. The cooking appliance includes one or more processors 302. The processor(s) 302 may be implemented as a central processing unit (CPU), a graphics processing unit (GPU), a hardware processor core, or any combination thereof. The processor(s) 302 may be in communication with one or more memory devices (e.g., the memory device 304). The processor(s) 302 may utilize the memory 304 to store programs in code and/or to store data for performing operations in accordance with the disclosure. The memory device 304 may be a non-transitory computer-readable storage medium or memory storing a vehicle control program code. The memory device 304 may include any one or a combination of volatile memory elements (e.g., dynamic random-access memory (DRAM), synchronous dynamic random-access memory (SDRAM), etc.) and may include any one or more nonvolatile memory elements (e.g., erasable programmable read-only memory (EPROM), flash memory, electronically erasable programmable read-only memory (EEPROM), programmable read-only memory (PROM), etc.). In some embodiments, the memory device 304 may include a module that can implement the various embodiments of the present disclosure. The module may include instructions that can be executed by the processor(s) 302 to realize the various embodiments of the present disclosure.

The cooking appliance may also include a communication interface 306. The communication interface may include a transceiver configured to communicate with one or more external devices, such as a user mobile device, using any of a number of transfer protocols (e.g., frame relay, internet protocol (IP), transmission control protocol (TCP), user datagram protocol (UDP), hypertext transfer protocol (HTTP), etc.). Example communications networks may include a local area network (LAN), a wide area network (WAN), a packet data network (e.g., the Internet), mobile telephone networks (e.g., cellular networks), plain old telephone (POTS) networks, wireless data networks (e.g., Institute of Electrical and Electronics Engineers (IEEE) 802.11 family of standards known as Wi-Fi®, IEEE 802.16 family of standards known as WiMax®), IEEE 802.15.4 family of standards, and peer-to-peer (P2P) networks, among others. In an example, the communication interface 306 may include one or more physical jacks (e.g., Ethernet, coaxial, or phone jacks) or one or more antennas to connect to the communications network. In an example, the communication interface 306 may include a plurality of antennas to wirelessly communicate using at least one of single-input multiple-output (SIMO), multiple-input multiple-output (MIMO), or multiple-input single-output (MISO) techniques. The communication interface 306 may also include one or more microphones that can receive audio from an external source. The cooking appliance 300 can support one or more voice assistants that can receive user audio and interpret the audio and cause the cooking appliance to perform one or more functions. For example, the cooking appliance 300 may receive verbal instructions to perform an action such as, operate based on a cooking mode. The cooking appliance 300 may interpret the verbal instructions and cause perform a set of operations based on the instructions. In some embodiments, the cooking appliance 300 may send information to a user device that causes the user device to operate as the display of the cooking appliance 300. A user may interact with the user device to enable remote control of the cooking appliance including but not limited to selecting a cooking mode, turn the cooking appliance on or off, sending control information, etc.

The cooking appliance 300 may further include one or more heating elements 308. The heating elements 308 may be implemented using coil elements, solid disk elements, radiant elements, induction elements, halogen elements or the like. The heating elements 308 may be implemented using nickel-chromium alloy (nichrome), iron-chromium-aluminum alloy (Kanthal), and other high-resistance materials. The cooking appliance 300 may also include an airflow control system 310. The airflow control system 310 may be similar to the airflow control system 30 described above and may include a fan/impeller/blower, venting mechanism, and baffles for airflow control. The cooking appliance also includes a user interface 312. The user interface 312 may include a touchscreen display, an alphanumeric input device, or a hybrid touch screen display with tactile controls. The cooking appliance may also include one or more sensors 314. The sensors 314 may include temperature sensors, tilt sensors, gyroscopes, accelerometers, ambient light sensors, and the like.

In an embodiment, the cooking appliance 300 may communicate with a user device such as a mobile phone, a tablet, a wearable device, etc. in order to receive data from and send data to the user device. The user device may communicate with the cooking appliance 300 to communicate control information (e.g., via an app), receive notifications, receive UI data for display on the screen of the mobile device, etc. In an embodiment, the screen of the user device may work in conjunction with the cooking appliance 300 to display specific information on the user device that is similar to or different from the information displayed on the display device of the cooking appliance 300.

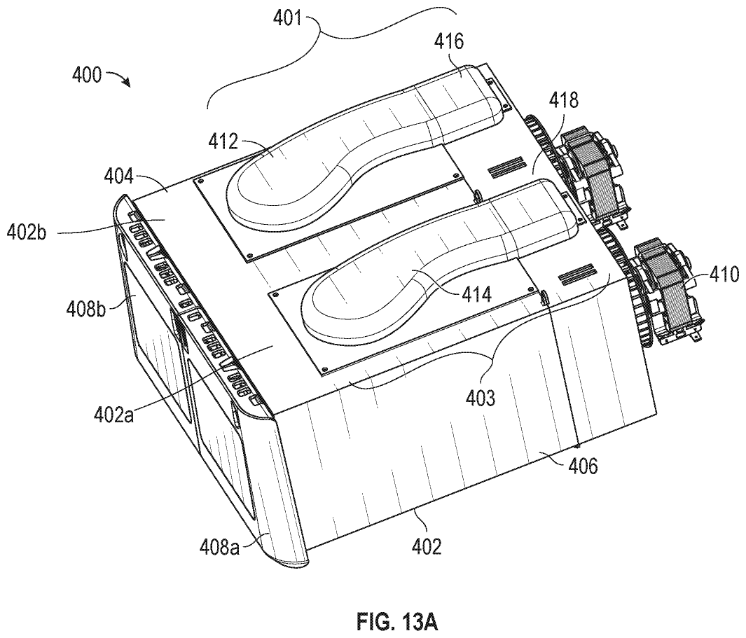

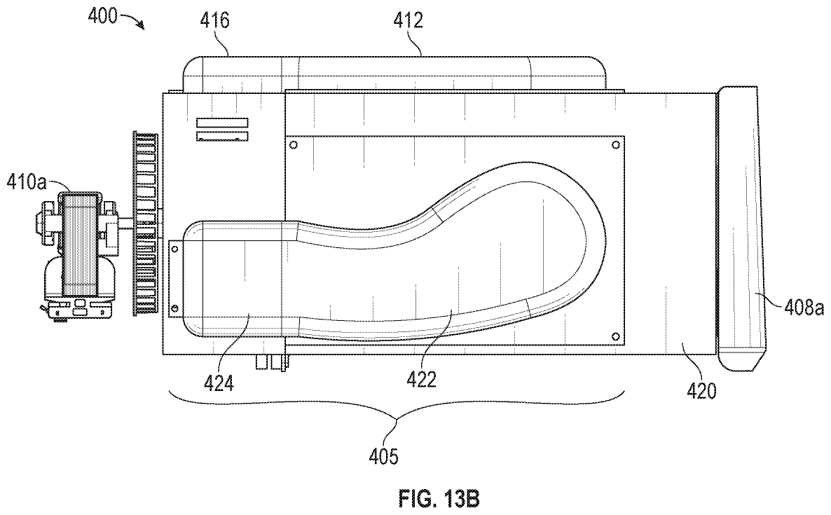

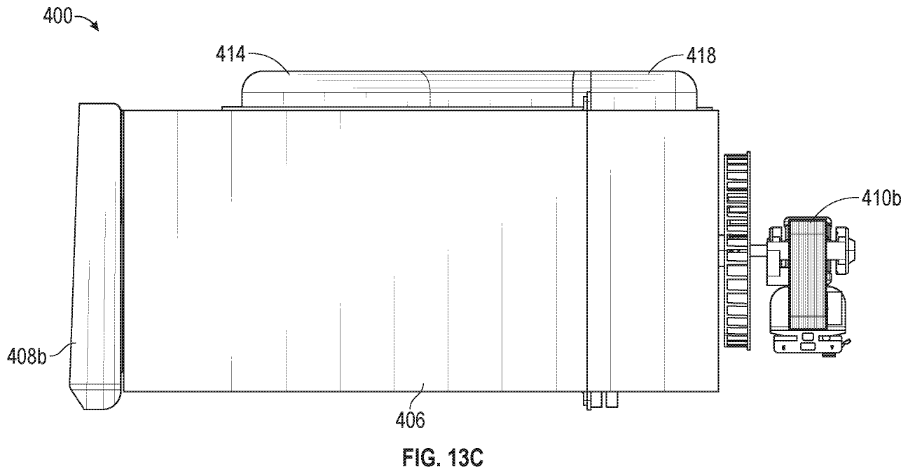

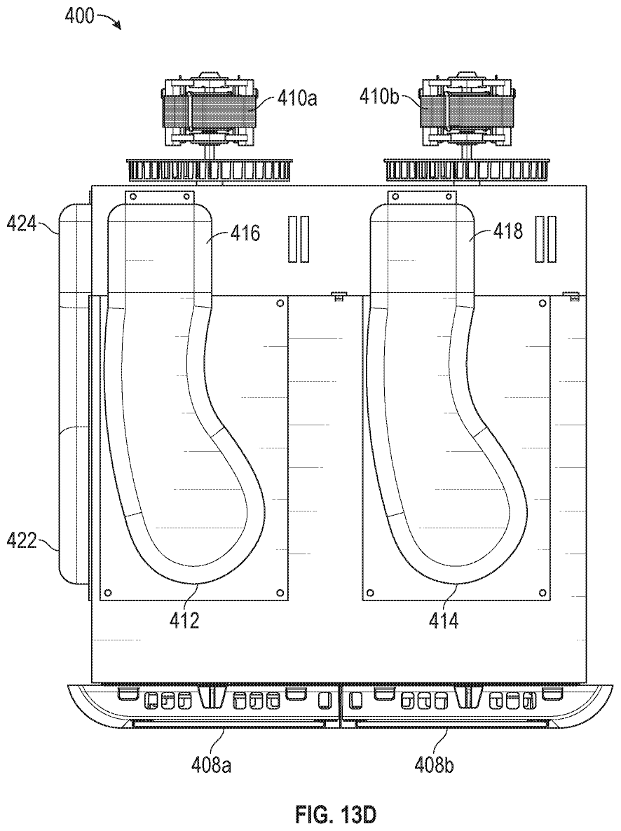

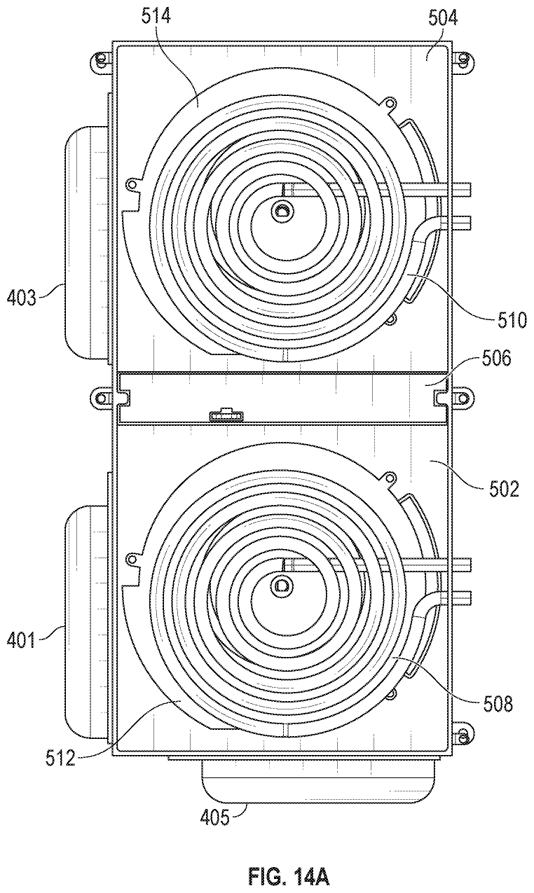

FIGS. 13A-13D illustrates various view of a cooking appliance 400 in accordance with the principles of the present disclosure. FIG. 13A illustrates a perspective view of the cooking appliance 400 in accordance with the principles of the present disclosure. The cooking appliance 400 may include a housing 402 that houses various functional components of the cooking appliance 400. In an embodiment, the housing 402 may be rectangular in shape, although this is not necessary. The housing 402 may be any suitable shape depending on the design of the cooking appliance 400. In a specific embodiment, the housing 402 may have a first side 404, a second side 406, a third side 420 opposing the second side 406, a fourth side, a fifth side opposing the first surface 404, and a sixth side opposing the fourth side. One or more doors 408a and 408b may be coupled to the sixth (e.g., front surface) side of the housing 402. The housing 402 may define one or more chambers 402a and 402b. The one or more doors 408a and 408b may be configured to close off or seal the one or more chambers when the appliance is being used. The back side of the housing 402 may have a first convective heating assembly with a motor control and heater control unit 410a and a second convective heating assembly with a motor control and heater control unit 410b coupled to it. Each motor control and heater control unit 410a and 410b may include control circuitry that is used to control operation of a respective fan coupled to it. The operation of the fan may include controlling the direction of rotation of the fan, the speed of rotation of the fan, and timing of the operation of the fan, etc. The fan is used to generate airflow that is directed towards the one or more chambers 402a and/or 402b. The heater control unit controls the operation of a heater element. The heater element heats the air generated by the fan. The heated air is then used for cooking the food item placed in the one or more chambers. The general operation of the cooking appliance may be similar to the various embodiments of the cooking appliance 10 described above.

The first side 404 of the housing 402 may include a first air flow path 401 and a second air flow path 403. In the illustrated embodiment, the first and second air flow paths 401 and 403 are channels defined in and along respective sides of the housing. However, in additional or alternative embodiments, the first and second air flow paths 401 and 403 can include portions of the housing 402 (or attached to the housing) that are angled or sloped, e.g., such as a conical or angle surface defined in or along a side of the housing 402. Each of the first air flow path 401 and the second air flow path 403 may be associated with an individual chamber of the one or more chambers of the cooking appliance 400. In an embodiment, the first air flow path 401 may include a first portion 416 and a second portion 412. The first portion 416 is closer to a first fan (not shown) and is fluidly coupled to the second portion 412. In operation, the air output by the first fan first enters the first portion 416 and is then directed to the second portion 412. Thereafter, the air is circulated within the chamber associated with the first air flow path 401. Similarly, the second air flow path 403 also includes a third portion 418 that is fluidly coupled with a fourth portion 414. The third portion 418 is closer to a second fan associated with the other chamber of the cooking appliance 400. The air output from the second fan may first enter the third portion 418 and then may be directed to the fourth portion 414 and then circulated within the chamber associated with the second air flow path 403. In some embodiments, where the cooking appliance 400 is used in a single chamber configuration (i.e., when a center divider separating the chambers is removed), both the first fan, the second fan, the first air flow path 401 and the second air flow path 403 work in conjunction to evenly distribute the air within the cooking appliance 400.

In an embodiment, the third side 420 may include a third air flow path 405 as illustrated in FIG. 13B. The third air flow path 405 may include a fifth portion 424 and a sixth portion 422 that is fluidly coupled with the fifth portion 424. In an embodiment where the cooking appliance is used in a vertical orientation, the air output from the first fan may first enter the fifth portion 424 and then may be directed to the sixth portion 422 before being circulated within the chamber. FIG. 13C illustrates a side view showing the second side 406. While there is no air flow path shown on the second side 406, in some embodiments, there may be another air flow path that may be integrated into the second side 406. FIG. 13D illustrates a top view of the cooking appliance 400. As can be seen, each of the motor control/heater control units 410a and 410b are configured to individually control a respective heater element and a fan coupled to each of the motor control/heater control unit 410a and 410b. Each of the two fans generate air flow that is directed via the respective first air flow path 401 and the second air flow path 405 when the cooking appliance 400 is used in the horizontal orientation. When the cooking appliance 400 is used in a vertical orientation, the air flow is directed via the third air flow path 405 and a fourth air flow path (not shown). The fourth air flow path may be integrated into a center divider, as explained below.

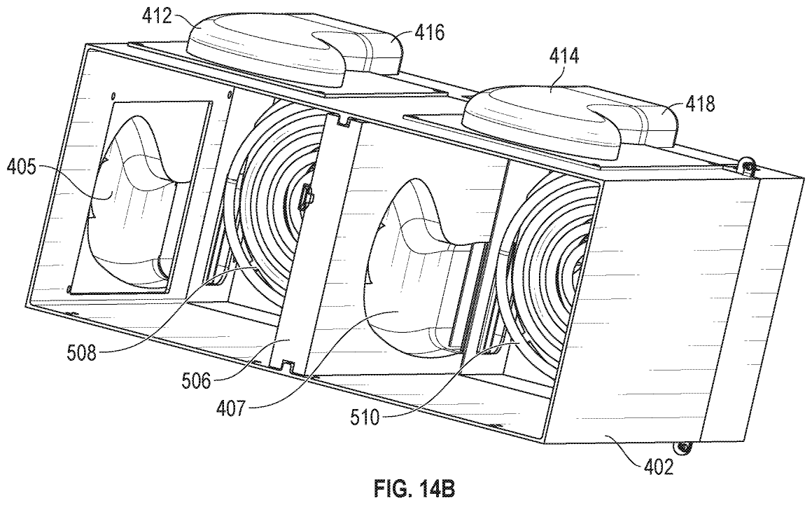

FIGS. 14A and 14B illustrate cross-sectional views of the cooking appliance 400 in accordance with the principles of the present disclosure. The view in FIG. 14A represents a front-side view of the cooking appliance 400. In the embodiment shown in FIGS. 14A and 14B, the cooking appliance 400 is being used in a two chamber configuration and in a horizontal orientation. As explained above, the cooking appliance 400 can be used in a horizontal or vertical orientation and in a single chamber or multi-chamber configuration. When used in a multi-chamber configuration, the cooking appliance 400 may include a first chamber 502 and a second chamber 504 defined within the housing 402. The first chamber 502 and the second chamber 504 may be separated by a divider 506. The divider 506 enables the two chambers 502 and 504 to be used separately and controlled individually such that each of the first chamber 502 and the second chamber 504 may be used to cook different types of food, run different recipes, etc. The first chamber 502 may include a first heating element 508 and the second chamber 504 may include a second heating element 510. Each of the first heating element 508 and the second heating element 510 may be individually controlled based on the cooking mode being used with each of the first chamber 502 and the second chamber 504.

The first chamber 502 may also include a first air flow director 512 and the second chamber 504 may include a second air flow director 514. The first air flow director 512 surrounds a first fan (not shown) that is coupled with the first chamber 502. The second air flow director 514 surrounds a second fan (not shown) that is coupled with the second chamber 504. In an embodiment, the first air flow director 512 directs the air output from the first fan to the first air flow path 401. Similarly, the second air flow director 514 directs the air output from the second fan to the second air flow path 403. When the cooking appliance is used in a vertical orientation, the first air flow director 512 may direct the air output from the first fan to the third air flow path 405 and the second air flow director 514 may direct the air output from the second fan to a fourth air flow path 407 that is integrated into the divider 506, as illustrated in FIG. 14B. In an embodiment, the heater element 508 may be placed in front of the air flow director 512 and the heater element 510 may be placed in front of the air flow director 514.

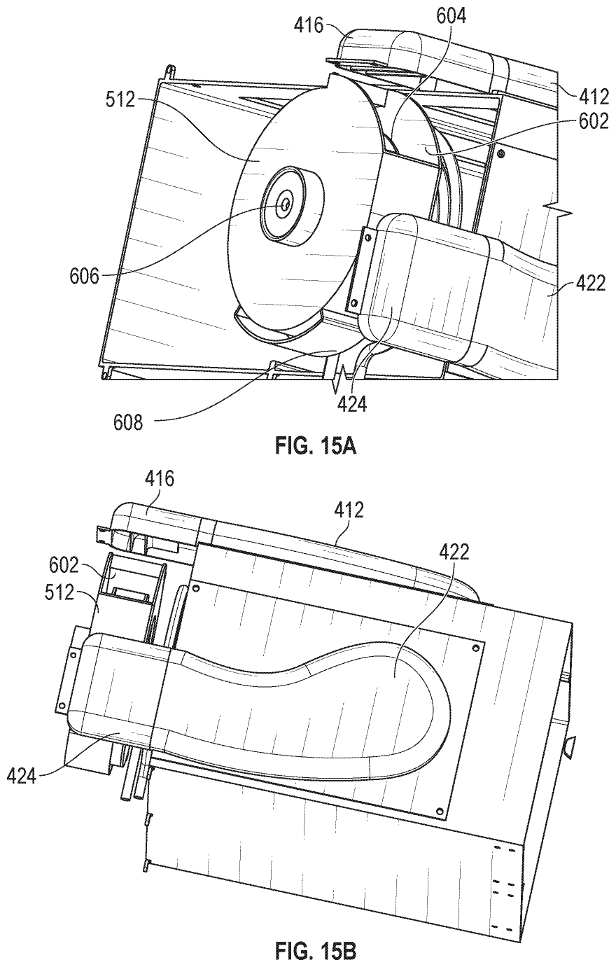

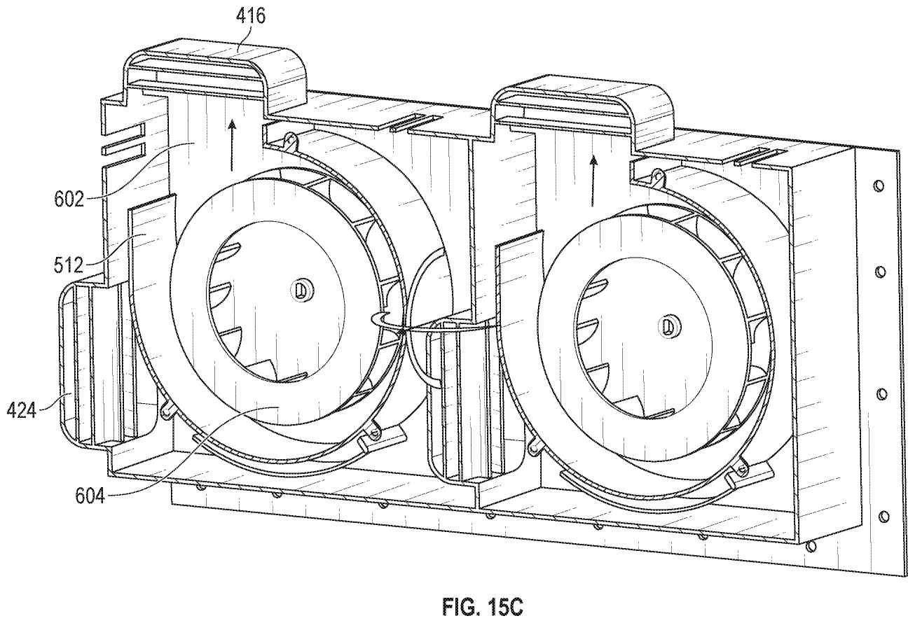

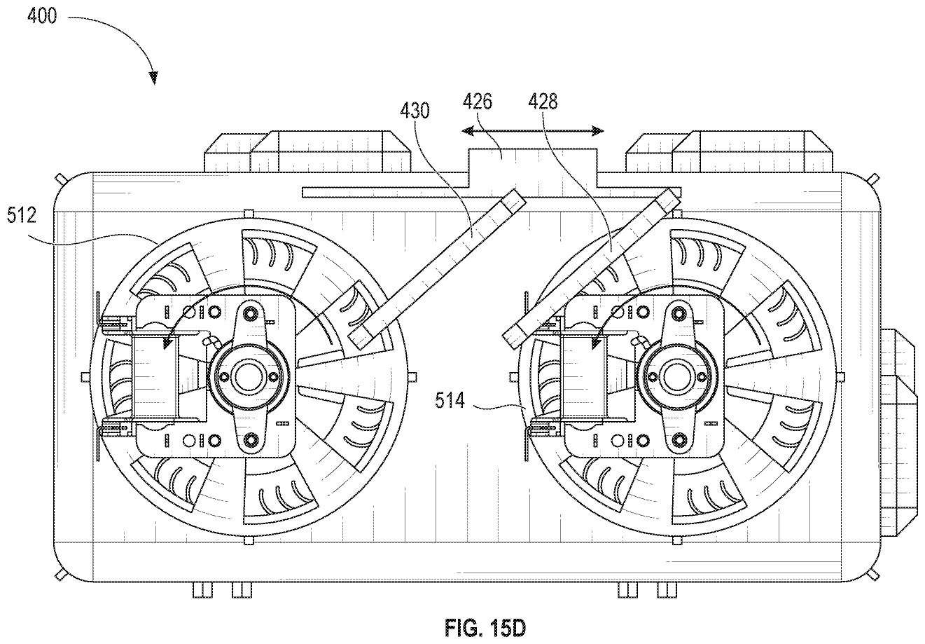

FIGS. 15A-15C illustrate details of the structure of the air flow path, the air flow director, and the fan and their relative orientations in accordance with the principles of the present disclosure. For ease of explanation, the figures illustrate details of a single air flow path, air flow director and the fan. However, it is to be understood that explanation is equally applicable for all the other air flow paths and air flow directors that may be present in the cooking appliance 400. FIG. 15A illustrates a close-up view of the air flow director 512 and the air flow path portions 412 and 416 of the air flow path 401. The air flow director 512 substantially surrounds a fan 604. The fan 604 is configured to output air based on the control signal received from the corresponding fan control unit of the cooking appliance 400. The air flow director 512 includes an opening 602 via which the air outputted by the fan 604 is directed towards the first portion 416 of the air flow path 401. The air flow director 512 is coupled to the housing 402 via a flange and may include high-temperature bearings. The air flow director 512 is coupled to the housing 402 such that it can freely rotate around an axis that passes through a center 606 of the air flow director 512. Since the air flow director substantially surrounds the fan 604, the air output from the fan 604 flows out via the opening 602 of the air flow director 512 and then is directed towards the first portion 416 of the air flow path 401. The fan 604 is connected to the motor control unit via a shaft (not shown) that also passed through the center 606 of the air flow director 512. Therefore, as the fan rotates, the air flow generated by the fan is directed by the air flow director 512 to the first portion 416 of the air flow path 401 via the opening 602.

The air flow director 512 may include weights or ballasts 608 incorporated into the air flow director such that the weights or ballasts 608 cause the air flow director 512 to rotate due to gravity. When the appliance is rotated between the horizontal and vertical configurations, gravity causes the ballast to move towards the counter, causing the air flow director 512 to rotate. This angular rotation of the air flow director 512 ensures that the ballast and air flow director 512 come to rest in a position where the opening 602 is aligned with the corresponding air flow path. As a result, the appliance is configured to selectively direct airflow based on its configuration or orientation. As noted above, the cooking appliance 400 can be used in the horizontal orientation or the vertical orientation. When the cooking appliance 400 is in the horizontal orientation, gravity and the weights or ballasts of the air flow director 512 cause the air flow director 512 to rotate around the center axis such that the opening 602 is aligned with the first portion 416 of the air flow path 401, as illustrated in FIG. 15C. In this orientation, the air from the fan 604 is directed towards the first portion 416 of the air flow path 401 by the air flow director 512. If the cooking appliance 400 is placed in a vertical orientation, the air flow director may automatically rotate, due to gravity and the weights/ballasts, such that the opening 602 may now align with the fifth portion 424 of the third air flow path 405. Similarly, the other air flow director may either align with the third portion 418 of the third air flow path 405 when the cooking appliance is in the horizontal orientation or align with the fourth air flow path 407 when the cooking appliance 400 is in a vertical orientation. Thus, the air flow directors 512 and 514 automatically rotate based on the orientation of the cooking appliance 400 to align with the appropriate air flow path 401, 403, 405, or 407.

In an embodiment, each of the air flow directors 512 or 514 may have additional baffles or air flow structures that can direct the air received from the corresponding fan to the corresponding opening 602 of the air flow director. The baffles included in the air flow directors 512 or 514 may include flat baffles, vane or turning baffles (i.e., curved or angled baffles), flat or curved perforated baffles, fixed or adjustable louvers with multiple blades/slats, chevron baffles, angled or curved deflector baffles, labyrinth baffles, guide vane baffles (i.e., curved plates arranged in a spiral or radial pattern), etc. The baffles may additionally help to direct the air flow in a specific direction and/or pattern.

In an embodiment, the motion of the air flow director 512 (and/or 514) may be controlled by a dedicated motor, such as a servo motor. The motor may be operated to selectively align the opening 602 of the air flow director 512 with any of the air flow paths of the housing 402. For instance, the housing 402 may also have additional air flow paths on the remaining sides of the housing 402 and on both sides of the divider 506. The motor may be controlled based on the cooking mode, the recipe being used, and/or the type of food being cooked to dynamically rotate the air flow director 512 to direct the air flow to any one of the air flow paths of the housing 402. For example, for a particular cooking mode, for a particular duration of time, the air flow director 514 may be controlled to direct the air flow to the air flow path 401. Then, after the expiration of the duration of time, the air flow director 512 may be rotated by the motor to align the opening 602 with the third air flow path 405 so that the air now flows via the third air flow path 405. Similarly, a recipe may dictate the type of air flow required within the cooking appliance. Based on the recipe being used, the air flow director 512 may be actively controlled by the motor to direct the air flow to different parts of the cooking appliance as needed. This will allow accurate control of air flow within the cooking appliance making the cooking appliance truly versatile and usable for cooking variety of food items in a variety of manner.

In another embodiment, the motion of the air flow director 512 may be controlled using a mechanical control, such as a lever, a slider, a button, or the like. A user of the cooking appliance 400 may manually operate the lever to rotate the air flow director 512, as needed, to direct the air flow within the cooking appliance 400. In an embodiment, the lever may be accessible from outside the housing 402 so that the operation of the cooking appliance may not be interrupted for rotating the air flow director 512. FIG. 15D illustrates an embodiment in which a mechanical control 426 may be movable between a first position and a second position to control air flow in accordance with the principles of the present disclosure. In an embodiment, the mechanical slider may be coupled to the housing of the cooking appliance and may be accessible from outside the cooking appliance. The mechanical control 426 may be coupled to the first air flow director 512 via a first link member 428. The mechanical control 426 may be coupled with the second air flow director 514 via a second link member 430. When the mechanical control 426 is placed in a first position, the first link member 428 and the second link member 430 are operable to cause the first air flow director 512 and the second air flow director 514 to align with a first set of air flow paths from among the air flow paths 410, 403, 405, and/or 407. When the mechanical control 426 is placed in a second position, the first link member 428 and the second link member 430 are operable to cause the first air flow director 512 and the second air flow director 514 to align with a second set of air flow paths from among the air flow paths 410, 403, 405, and/or 407. In an embodiment, the first set and the second set of airflow paths may be distinct. In other embodiments, there may be an overlap between the first set and the second set of air flow paths. In some embodiments, instead of an individual link member coupling the mechanical control 426 with a respective air flow director, a single link member may couple the mechanical control 426 to a plurality of air flow directors of the cooking appliance. In an embodiment, the position of the mechanical control 426 may depend on the orientation of the cooking appliance. For example, when the cooking appliance is in a first orientation, the mechanical control 426 may be placed in the first position and when the cooking appliance is in a second orientation, the mechanical control 426 may be placed in the second position. In other embodiments, there may be multiple mechanical controls 426 that each control a respective air flow director.

In the instance when the divider 506 is removed, the entire cooking appliance 400 may act as a single chamber system. The cooking appliance 400 may have a mechanical and/or an electrical sensor, or a combination thereof to indicate presence or absence of the center divider 506. In this embodiment, the first convective heating assembly with the motor control and heater control unit 410a and the second convective heating assembly with a motor control and heater control unit 410b may be operated in a manner so as to ensure even flow of air within the cooking appliance depending on the orientation of the cooking appliance 400. For example, in an embodiment where the center divider 506 is absent, depending on the orientation of the cooking appliance, the cooking mode, the recipe being used, and/or the food being cooked, the first convective heating assembly with the motor control and heater control unit 410a may be turned off and only the second convective heating assembly with the motor control and heater control unit 410b may be operational. In other embodiments, one or both of the heating assemblies may be operated at a lower temperature, one or both of the fans can be operated at different speeds and/or directions, etc. In another embodiment, when the center divider is removed, the user interface associated with the cooking appliance may output an indication informing the user that the center divider 506 is removed. The indication may be in the form of a visual output, an audio output, a message sent to a user device, or a combination thereof.

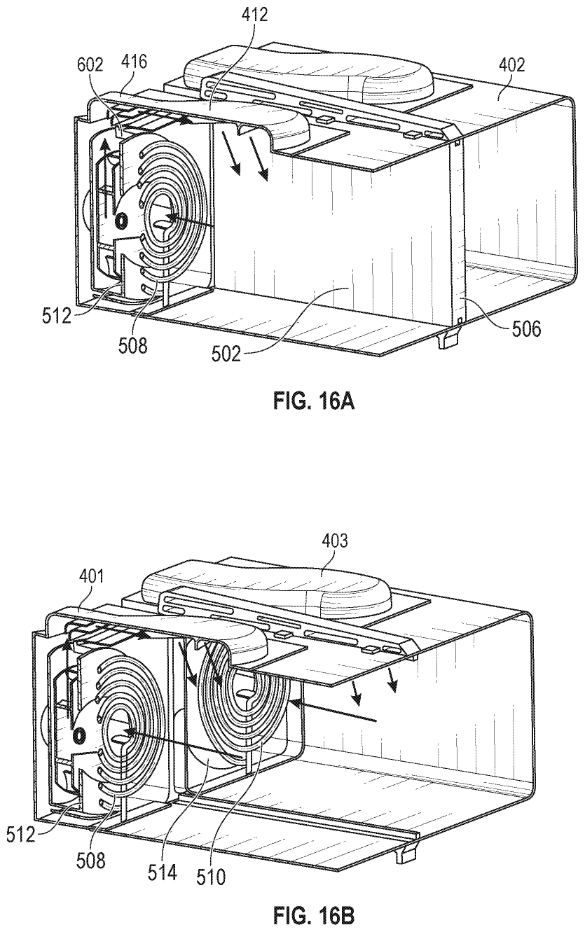

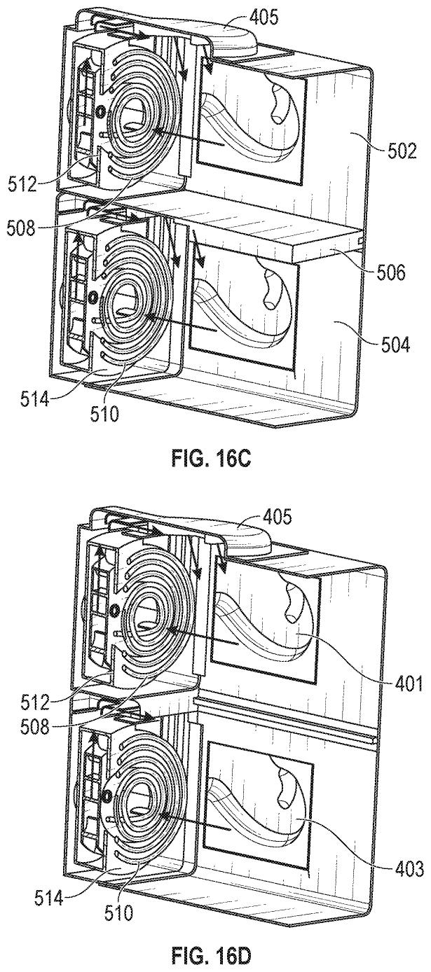

FIGS. 16A-16D illustrate some examples of the air flows within the cooking appliance 400 in accordance with the principles of this disclosure. FIG. 16A illustrates an example where the cooking appliance is in the horizontal orientation and the divider 506 is installed effectively defining at least two different cooking chambers 502 and 504 in the cooking appliance 400. Only the details of the chamber 502 are shown for ease of explanation. When the cooking appliance 400 is in use, the fan may operate generating air flow. Since the opening 602 of the air flow director 512 is aligned with the first portion 416 of the air flow path 401, the air from the fan flows through the first portion 416 of the air flow path 401 and then through the second portion 412 of the air flow path 401. The air exits the air flow path 401 and is circulated in the chamber 502. The various arrows of FIG. 16A illustrate the air flow path in this orientation.

FIG. 16B illustrates a scenario in which the cooking appliance is being used in the horizontal orientation without the divider 506. Hence, in this instance, the entire cooking appliance 400 has a single chamber configuration. For example, this configuration may be used for cooking a large food item (e.g., a turkey). In this scenario, both the fans and the heater elements 508 and 510 may be individually and dynamically operated per the cooking requirements. The first air flow director 512 and the second air flow director 514 are aligned such that the air from the first fan is directed towards the air flow path 401 by the air flow director 512 and the air from the second fan is directed towards the second air flow path 403 by the air flow director 514. This is illustrated by the directional arrows in FIG. 16B. FIG. 16C illustrates a scenario in which the cooking appliance 400 is being used in the vertical orientation. In this scenario, the divider 506 divides the cooking appliance into the two chambers 502 and 504, similar to FIG. 16A. As explained above, when the cooking appliance is placed in the vertical orientation, the first air flow director 512 and the second air flow director 514 rotate due to gravity and the weights/ballasts in each of the air flow directors. The rotation of the air flow directors 512 and 514 aligns the respective openings of the two air flow directors with the third air flow path 405 and the fourth air flow path 407, which is integrated into the divider 506 as explained above, respectively. The arrows in FIG. 16C illustrate the air flow path in this scenario. FIG. 16D illustrates a scenario in which the cooking appliance 400 is being used in a vertical orientation with the divider 506 removed. In this configuration, the cooking appliance 400 only has a single chamber. The two fans and heating elements 508 and 510 may be individually and dynamically operated and each of the air flow directors 512 and 514 may direct the air flow in the manner depicted by the arrows in FIG. 16D.

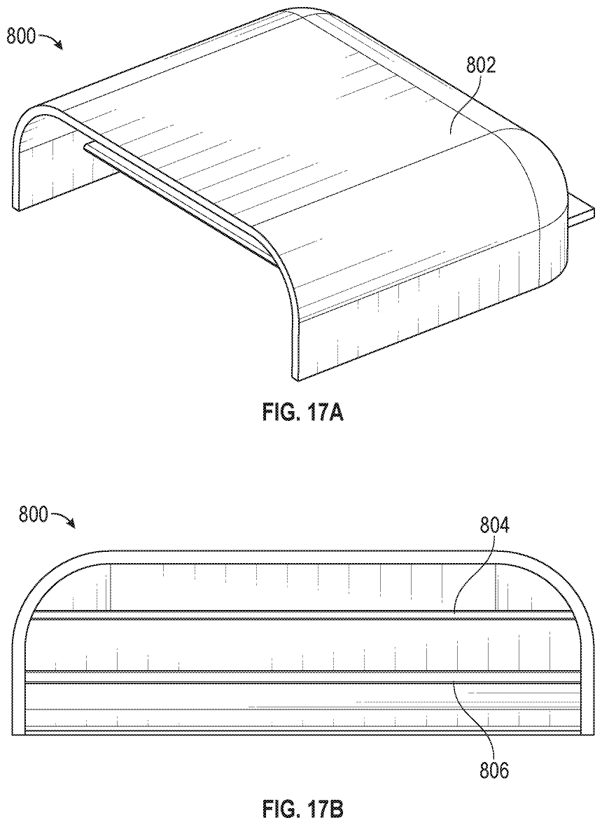

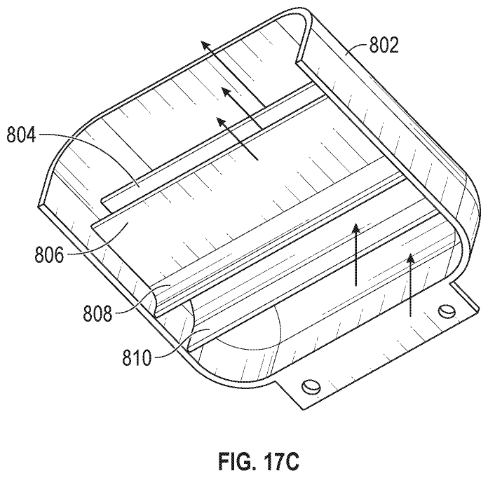

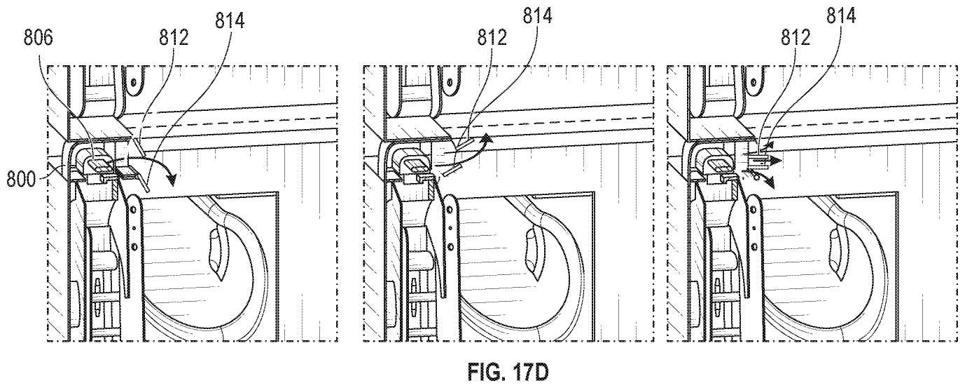

FIGS. 17A-17C illustrate various views of a portion 800 of an air flow path (e.g., air flow paths 401, 403, 405, or 407) in accordance with the principles of the present disclosure. The portion 800 may correspond to the first portion 416 of the air flow path 401, the third portion 418 of the air flow path 403, or the fifth portion 424 of the air flow path 405. In an embodiment, the portion 800 may be referred to as a 90-degree turn divider since the air enters the portion 800 in a first direction from the air flow director and exits the portion 800 in a second direction that is orthogonal to the first direction. The portion 800 of the air flow path may include a housing 802. The housing 802 may define a recessed region. A first baffle 804 and a second baffle 806 may be disposed in the recessed region, as illustrated in FIG. 17B. In another embodiment, the housing 802 may include more than two baffles or even a single baffle. Each of the first baffle 804 and the second baffle 806 helps to direct the air flow in a specific manner toward the second portion of the respective air flow path. In an embodiment, the first baffle 804 and the second baffle 806 are arranged in a stack configuration which the first baffle 804 is separated from the second baffle in a vertical direction by a certain distance. The first baffle 804 and/or the second baffle 806 may be any of the different types of baffles described above. In an embodiment, the first baffle 804 may include a curved portion 810 and a planar portion. Similarly, the second baffle 806 may include a curved portion 808 and a planar portion. The curved portions 808 and 810 receives the air from the air flow director and direct the air over/under the respective planar portions of the baffles 804/806 and towards the second portion of the air flow path. FIG. 17C illustrates the air flow path via the portion 800 using the arrows. As can be seen, air enters the portion 800 from a bottom side, curves/turns approximately 90 degrees and exists the portion 800 towards the other portion of the air flow path. Since there are two baffles 804 and 806, this results in two air flow paths that are parallel to each other, as illustrated in FIG. 17B. It is to be noted that the baffles 804/806 need not be arranged as shown in FIGS. 17A-17C, and other arrangements of one or more baffles is possible based on the air flow requirements and the design of the cooking appliance 400. All such arrangements of baffles are within the scope of this disclosure.

FIG. 17D illustrates an alternate embodiment for the air flow within the cooking appliance in accordance with the principles of the present disclosure. In this embodiment, the portion 800 of the airflow path includes additional one or more air flow control features 812 and 814 that may be coupled to one end of the portion 800. While the baffles 806 and 804 are static, the one or more airflow control features 812 and/or 814 may be either static or movable. Depending on the orientation of the cooking appliance, the one or more air flow control features 812 and/or 814 may be positioned to further manage the flow of air into the cooking appliance. In an embodiment, the presence of the one or more air flow control features 812 and/or 814 may negate the need for having air flow channel/path 900. Instead, the baffles 804/806 and the air flow control features 812/814 of the portion 800 may cause the air to be directed and circulated within the cooking appliance based on the orientation of the cooking appliance. In other words, the opening of the air flow director (e.g., air flow director 512) may align with the appropriate portion of the selected air flow channel/path in order to direct and circulate the heated air within the cooking appliance 400. FIG. 17D illustrates three possible air flow configurations, but one skilled in the art will realize that additional air flow configurations may be possible by adjusting the number of air flow control features and their respective locations.

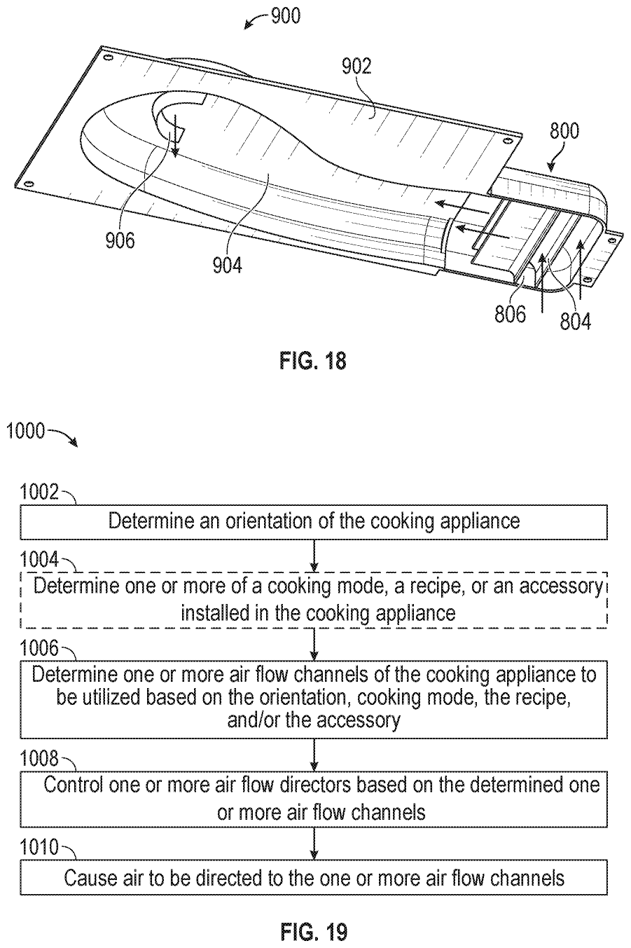

FIG. 18 illustrates details of an air flow path 900 in accordance with the principles of the present disclosure. The air flow path 900 may be the same as the air flow paths 401, 403, 405, and 407 described above. The air flow path 900 includes the first portion 800 and a second portion 902. The second portion 902 may correspond to the portions 412, 414, and 422 described above. In an embodiment, the first portion 800 and the second portion 900 may be a single integrated structure manufactured using any known metal processing techniques. In an embodiment, the second portion 902 defines a recessed region 904 that may include one or more baffles/air flow modifiers 906. The baffle 906 may be any type of baffle described above. Further, the placement of the one or more baffles 906 may be based on the design of the air flow path 900, the air flow requirements, and/or the design of the cooking appliance 400. In an embodiment, the second portion 902 receives the air directed by the first portion 800. The one or more baffles 906 help to direct the air into the respective cooking chamber of the cooking appliance 400 (e.g., as illustrated in FIGS. 16A-16D above). The air flow direction within the air flow path 900 is depicted with bold arrows in FIG. 18. In some embodiments, the individual baffles in the air flow paths and/or the air flow directors may be individually controllable to manage the flow of air within the cooking appliance. For instance, the one or more baffles may be louvers that may be controlled using electronic actuators. The electronic actuators can be selectively activated to position the louvers in a specific pattern or orientation to control the air flow direction within the cooking appliance 400.

As explained above, the cooking appliance 400 may include one or more air flow directors (e.g., air flow directors 512/514) and one or more air flow paths (e.g., air flow paths 401/403/405/407). Each of the air flow directors and/or the air flow paths may include one or more baffles to direct and control the air flow within the cooking appliance 400. The cooking appliance 400 may be programmed to selectively use any of the one or more air flow directors and/or the one or more air flow paths to control and direct air flow within the cooking appliance 400. In one embodiment, the cooking appliance may select one or more air flow directors and/or one or more air flow paths based on the cooking mode. For example, in a first cooking mode, the cooking appliance 400 may choose a first set of the one or more air paths to control the flow of air within the cooking appliance 400. In a second cooking mode, the cooking appliance may use a second set of air flow paths to control the flow of air within the cooking appliance. In an embodiment, the first set of air flow paths and the second set of air flow paths may partially overlap between the two cooking modes, while in other embodiments, the two sets of air flow paths may be completely separate between the two cooking modes. In some embodiments, the cooking appliance 400 may selectively use one or more air flow paths based on the recipe being used. For example, The cooking appliance may use a first set of one or more air paths during a first portion of the receipt and then use a second set of one or more air flow paths during a second portion of the recipe. In an embodiment, the first set and the second set may partially overlap, while in other embodiments the first set and the second set may be distinct.

In some embodiments, the cooking appliance 400 may selectively utilize one or more air flow paths based on the type of food being cooked. For instance, the cooking appliance 34 the top and the side air flow paths when cooking a second food type. In other embodiments, the cooking appliance 400 may selectively utilize one or more air flow paths based on the type of accessory installed in the cooking appliance. For example, if a cooking basket (e.g., basket accessory 90) is placed in one of the chambers 502 or 504, the cooking appliance 400 may selectively choose to utilize one or more specific air flow paths such that the air flow within the chamber is evenly distributed to cook the food placed in the basket. In another example, if the accessory is a skewer, a different set of air flow paths may be utilized. It is to be noted that in order to selectively utilize any of the one or more air flow paths, the corresponding air flow director is controlled accordingly to direct the flow of air from the respective fan to the selected air flow channel. In order to accomplish this, the control motor for the air flow director may receive an input from the main control board/logic of the cooking appliance 400. Based on the cooking mode, the recipe, the orientation of the cooking appliance, the type of food, and/or the accessory installed in the cooking appliance, the main control board/logic of the cooking appliance may send a control signal to the controller of the air flow director causing the controller to maneuver the air flow director to output air towards the selected one or more air flow paths.

FIG. 19 illustrates a flow diagram 1000 of a process for managing air flow within a cooking appliance in accordance with the principles of the present disclosure. Process 1000 may be performed by the cooking appliance 400 in an embodiment. At step 1002, the cooking appliance may determine its orientation. As explained above, the cooking appliance can be used in a horizontal or a vertical orientation. Also, certain cooking modes and/or recipes may be only enabled in a particular orientation. After the cooking appliance determines its orientation, the cooking appliance may then further determine which cooking mode and/or recipe is currently selected and whether there is any specific accessory installed in the cooking appliance, at step 1004. In some embodiments, step 1004 may be optional as illustrated by the dashed box in FIG. 19. Once the cooking appliance determines its orientation and/or the cooking mode, the recipe, and/or the accessory currently installed in the cooking appliance, the cooking appliance may then determine one or more of the air flow paths that are to be utilized in order to operate the cooking appliance (step 1006) based on the orientation, the cooking mode, the recipe, and/or the accessory. Thereafter, the cooking appliance may control the one or more air flow directors, at step 1008, based on the selected one or more air flow paths to ensure that the air is directed to the one or more air flow paths based on the selection. At step 1010, the cooking appliance may cause the air output by one or more of its fans to be directed according to the selection of the air flow paths.

As explained above, the selection of the one or more air flow paths may also include a time associated with the selection of the air flow paths. For example, a first air flow path may be selected for a first duration of time and then a second air flow path may be selected for a second duration of time. In this instance, the air flow director may be controlled to direct the air flow to the first air flow path for the first duration and to direct the air flow to the second air flow path for the second duration. Further, the baffles within the air flow director and/or the air flow paths may be individually controlled to further refine the air flow within the cooking appliance. In this manner, the cooking appliance can provide a robust and fine-tuned control of air flow within the cooking appliance. This enables the cooking appliance 400 to be used for a variety of cooking purposes by providing dynamic and precise control of air flow within the cooking appliance.

In an embodiment, instead of having the air flow paths as described above, one or more surfaces of the housing of the cooking appliance 400 may be shaped in a manner so as to cause the air flow to occur in a specific pattern. For instance, one or more surfaces of the cooling appliance 400 may be curved, sloped, conical, elliptical, or otherwise designed in a manner to cause the air flow within the cooking appliance 400 to occur in a specific manner, depending on the orientation of the cooking appliance. In an embodiment, one or more surfaces of the cooking appliance may have a different design to influence the air flow. For instance, when the cooking appliance 400 is being used in a first orientation, the top surface of the cooking appliance may be curved, sloped, or otherwise design in a manner to cause the air flow to be directed from the top of the chamber toward the bottom of the chamber. When the cooking appliance 400 is being used in a second orientation, the side surfaces of the cooking appliance may cause the air flow to be directed from the sides and then toward the center of the cooking appliance. Similar to above, the orientation of the cooking appliance may determine which of the surfaces of the cooking appliance are used for the air flow control and direction within the cooking appliance.

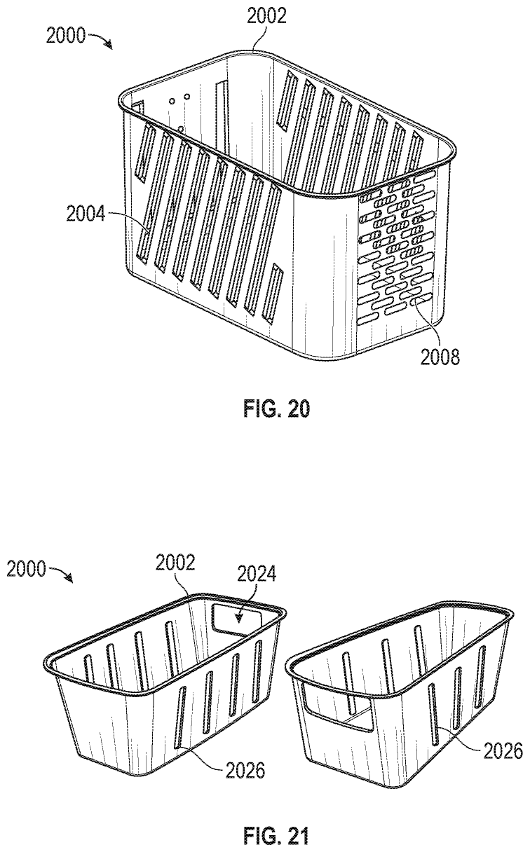

In some embodiments, the accessory that may be installed in the cooking appliance may contribute to the air flow control within the cooking appliance. FIG. 20 illustrates an accessory 2000 that may enable control of air flow in accordance with the principles of the present disclosure. The accessory 2000 may include a body 2002. The body 2002 may include a first set of slots or openings 2004 and a second set of slots or openings 2008. When the accessory 2000 is placed in the cooking appliance either the first set of slots 2004 and/or the second set of slots 2008 may help direct the flow of air in order to cook the food item placed inside the accessory 2000. In an embodiment, depending on the orientation of the cooking appliance, either the first set of slots 2004 or the second set of slots 2008 may help direct the air flow towards the inside of the accessory 2000 and distribute the air flow evenly to achieve optimized cooking performance based on the recipe being used and/or the food item being cooked. In other embodiments, the accessory 2000 may work in conjunction with the one or more air flow paths described above to further manage the air flow pattern within the cooking appliance.

FIG. 21 illustrates another accessory 2020 in accordance with the principles of the present disclosure. The accessory 2020 may be uniquely shaped to control or manage the airflow within the cooking chamber. The accessory 2020 may include a body 2022 and an opening 2024. The opening 2024 may act as a handle for the accessory 2020 as well as function as an inlet for the heated air output by the cooking appliance. In an embodiment, the accessory 2020 may have a tapered shape to draw air towards the accessory 2020 and the accessory 2020 may have one more air flow control features 2026 designed to allow the heated air to circulate evenly within the accessory 2020. In an embodiment, the accessory 2020 may direct the flow of air within the cooking appliance based on the orientation of the cooking appliance. For example, when the cooking appliance is being used in a first orientation, the accessory 2020 may help direct the flow air within the cooking appliance is a first pattern and when the cooking appliance is being used in a second orientation, the accessory 2020 may help direct the flow of air in a second pattern that is different than the first pattern. Thus, in this embodiment, the change in orientation of the cooking appliance causes the output of the fan to align with the orientation of the accessory 2020 that is within the cooking appliance such that the one or more air flow control features 2026 cause the air to circulate in the desired pattern.

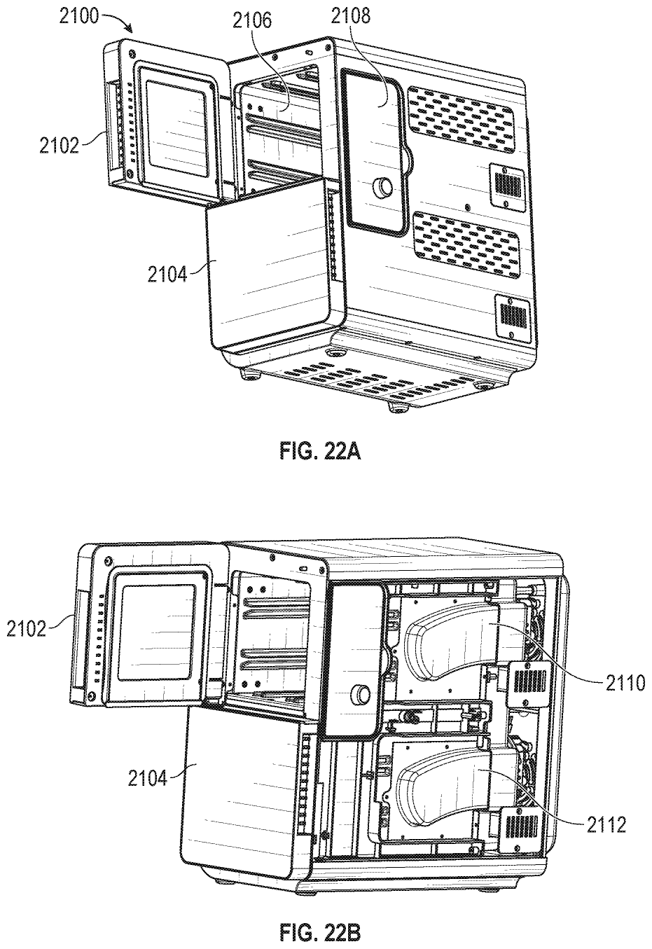

FIGS. 22A and 22B illustrate a reconfigurable cooking appliance 2100 in accordance with the principles of the present disclosure. The reconfigurable cooking appliance 2100 may be similar in functionality to the cooking appliance 10, 300, and/or 400 described above. The cooking appliance 2100 may have a housing that defines two individual chambers or a single chamber that may be used for cooking multiple different types of food. The cooking appliance 2100 may include a first door 2012 and a second door 2104. The first door 2102 may seal a first chamber 2106 and the second door 2104 may seal a second chamber (not shown). The cooking appliance may further include a control unit 2108. In an embodiment, the control unit may have a similar function as that of the control unit/display 20 described above. The cooking appliance 2100 can be used either in a vertical orientation or a horizontal orientation. The cooking appliance 2100 may include multiple air flow channels. As illustrated in FIG. 22B, the cooking appliance may include a first air flow channel 2110 and a second air flow channel 2112. The first air flow channel 2110 may be associated with the first chamber 2106 and the second air flow channel 2112 may be associated with the second chamber when the cooking appliance is used in a two-chamber configuration. The cooking appliance 2100 may include two additional air flow chambers (not shown) that may each be associated with a corresponding chamber. When the cooking appliance 2100 is used in a single-chamber configuration, one or more of the four air flow channels may be selectively used to direct flow of air within the single chamber depending on the orientation of the cooking appliance 2100. The cooking appliance 2100 can be used in the following configurations, (i) single-chamber vertical orientation, (ii) single chamber horizontal orientation, (iii) dual chamber vertical orientation, and (iv) dual chamber horizontal orientation.

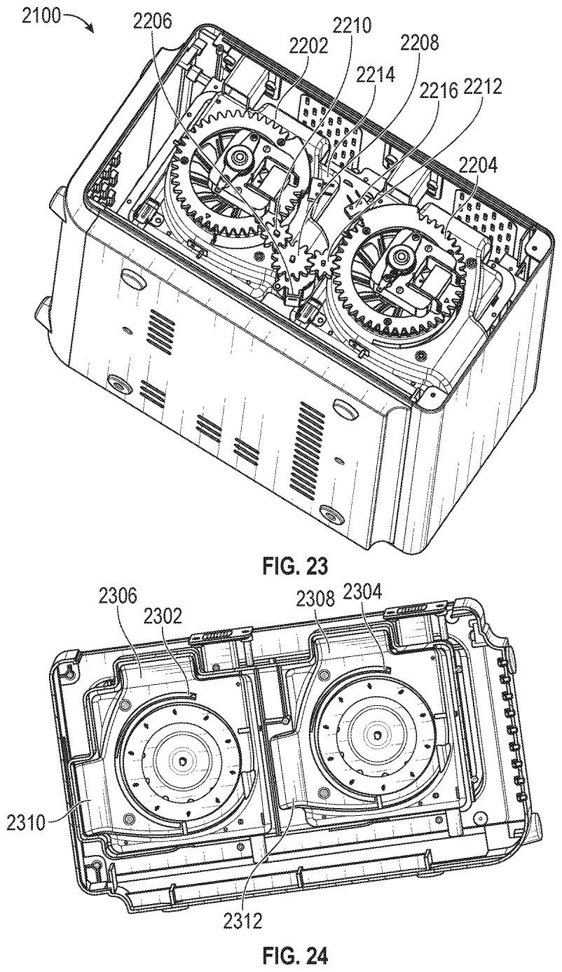

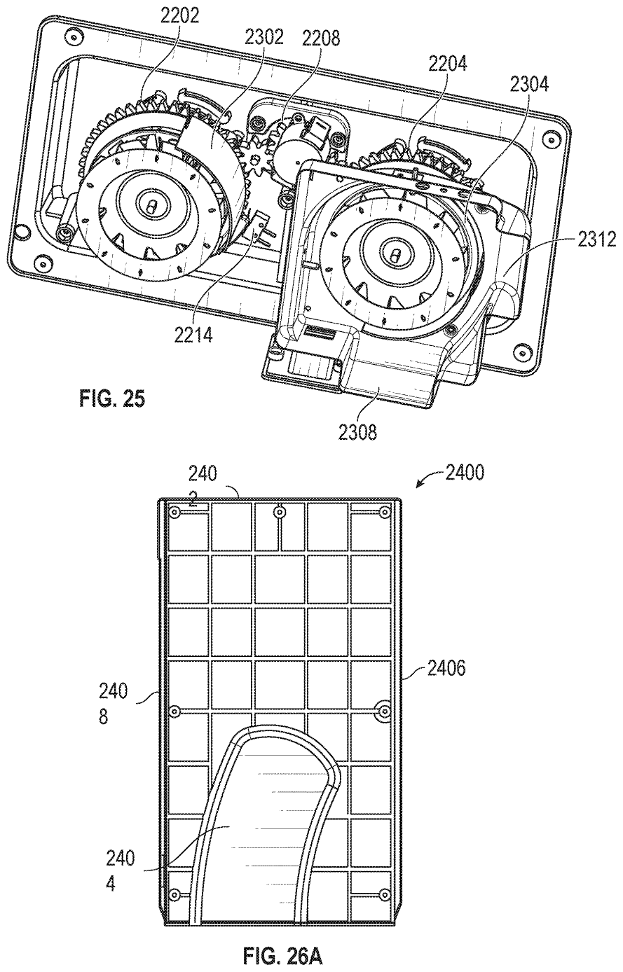

In order to control and direct the flow of air within the cooking appliance 2100, a pair of movable deflectors/air flow directors may be used. FIG. 23 illustrates a partial back view of the cooking appliance 2100 showing the air flow control assembly in accordance with the principles of the present disclosure. FIGS. 24 and 25 illustrate cross-sectional views of the cooking appliance illustrating the air flow director in accordance with the principles of the present disclosure. As explained above, the cooking appliance 2100 can be used in a vertical orientation or in a horizontal orientation. In each of these orientations, the air flow within the cooking appliance is controlled precisely to provide optimal cooking experience. The cooking appliance 2100 may include two air flow control assemblies that are capable of operating independently of each other or in sync with each other based on the cooking mode, type of food being cooked, the orientation and configuration of the cooking appliance 2100 and the like. When the cooking appliance 2100 is used in a two-chamber configuration, each chamber of the cooking appliance 2100 may be served by its associated air flow control assembly. When the cooking appliance is used in a single-chamber configuration, the two air flow assemblies may work in concert with each other to control and direct the air flow within the chamber.

A first air flow control assembly may include a first gear wheel 2202, a first microswitch 2214 and a first sprocket wheel 2210. The first sprocket wheel 2210 engages with the first gear wheel 2202 and motor gear 2208. The second air flow control assembly may include a second gear wheel 2204, a second microswitch 2216, and second sprocket wheel 2212. The second sprocket wheel 2212 engages with the second gear wheel 2204 and the motor gear 2208. The motor gear 2208 may be coupled to a motor 2206. The motor 2206 may drive both the first sprocket wheel 2210 and the second sprocket wheel 2212, which is turn drive the first gear wheel 2202 and the second gear wheel 2204. The first gear wheel 2202 may be coupled to a first air flow director 2302 and the second gear wheel 2204 may be coupled to a second air flow director 2304. The movement of the first gear wheel 2202 and the second gear wheel 2204 results in the rotation of the corresponding air flow directors. Based on the position of the first air flow director 2302 and/or the second air flow director 2304, air flow is either directed to the air flow channels 2306 and 2308 or 2310 and 2312, similar to the other embodiments described above.

When the cooking appliance 2100 is changed from the vertical orientation to the horizontal orientation and vice-versa, the first microswitch 2214 and the second microswitch 2216 detect the change in orientation. Based on the detection, each of the first microswitch 2214 and the second microswitch 2216 sends a signal to a motor control board that controls the motor 2206. The motor control board operates the motor 2206 to cause the first gear wheel 2202 and the second gear wheel 2204 to rotate either in the clockwise direction or the anti-clockwise direction. This causes a corresponding rotation of the first air flow director 2302 and the second air flow director 2304. As a result, the air flow is switched between the air flow channels 2306/2308 and 2310/2312.

FIG. 25 illustrates a partial cross-sectional view illustrating the details of the first air flow director 2302 and air flow channels 2310 and 2312 in accordance with the principles of the present disclosure. For ease of explanation, the left side of the cooking appliance 2100 is shown with the air flow channels 2306 and 2310 removed and the right side of the cooking appliance 2100 is illustrated with the air flow channels 2310 and 2312 in place. Based on the position of the first air flow director 2302 and the second air flow director 2304, either the air flow channel 2312 is blocked or the air flow channel 2308 is blocked. This enables proper control of air flow based on the orientation of the cooking appliance 2100 by appropriately positioning the first air flow director 2302 and the second air flow director 2304. In other embodiments, the first air flow director 2302 and the second air flow director 2304 may positioned anywhere along the 360 degree rotation angle such that concurrent partial air flow may be allowed via each of the four air flow channels 2306, 2310, 2312, and 2308.

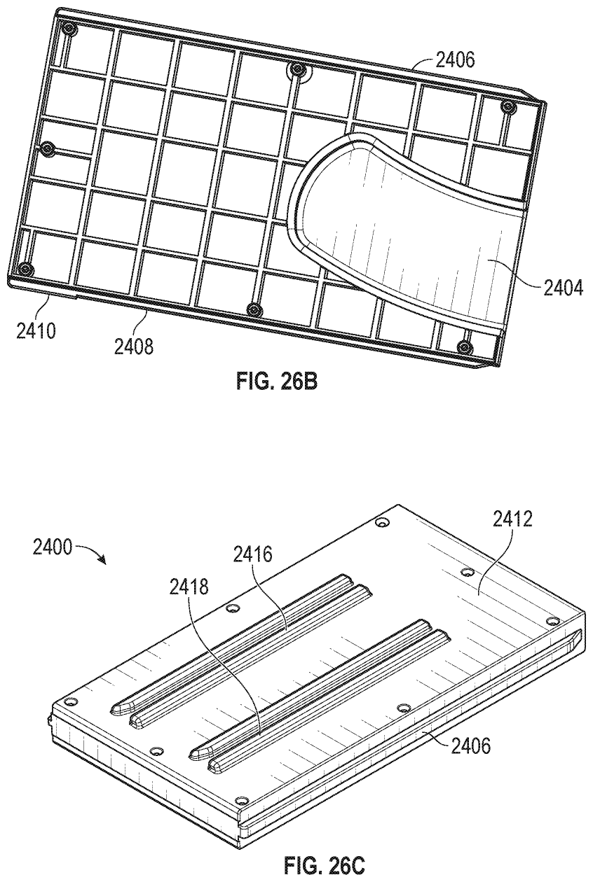

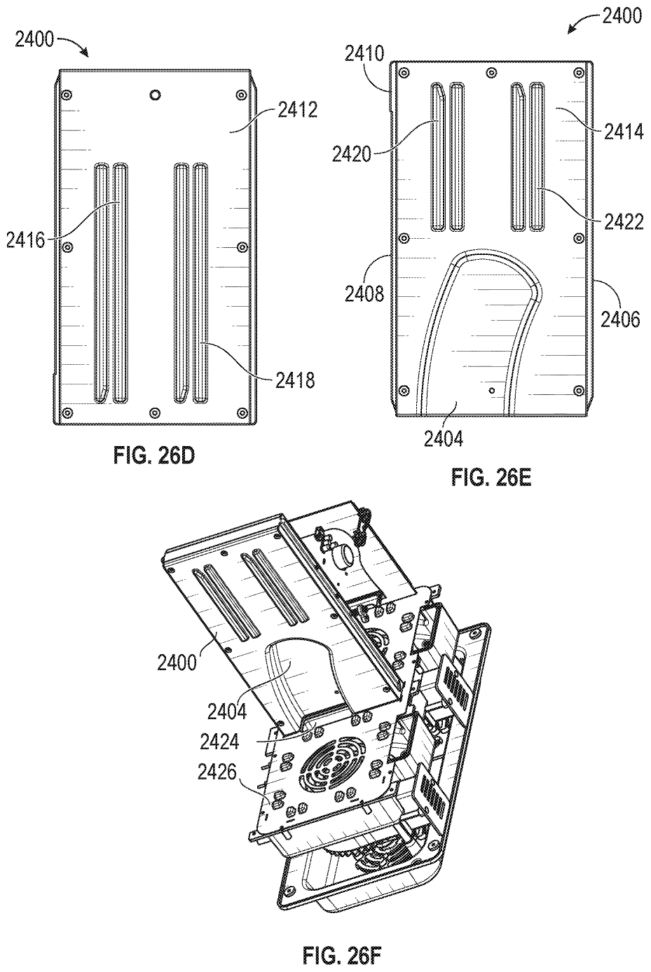

As explained above, the cooking appliance 2100 may be used in a single chamber configuration or a two-chamber configuration. In order to operate the cooking appliance 2100 in a two chamber configuration, a center divider may be employed to define the two chambers. FIGS. 26A and 26B illustrate a center divider 2400 in accordance with the principles of the present disclosures. In some embodiments, the center divider 2400 may perform a similar function as the dividers 24 and 506 described above. The center divider 2400 may include a rigid frame 2402. In an embodiment the frame 2402 may be rectangular and can be made of a material that is approved for use in a cooking appliance and that can withstand the temperatures expected within the cooking appliance during operation. The center divider 2400 may include an air flow channel 2404 incorporated into one side/surface of the center divider 2400. The opposing side/surface does not have a corresponding air flow channel. When the center divider 2400 is used, the air flow control system of each individual chamber of the cooking appliance can selectively direct the air flow via the air flow channel 2404. In an embodiment, the first airflow channel 2110, the second airflow channel 2112 (illustrated in FIG. 22B), the airflow channel 2404 of the center divider 2400 (illustrated in FIG. 26B), and any other airflow channels, such as airflow channels 412, 414, and 422 (illustrated in FIGS. 13A and 13B), do not include any air flow directing structures such as baffles or guide vanes. In another embodiment, one or more of the cooking chambers of the cooking appliance 10, 100, 400, or 2100 do not include any air flow directing structures such as baffles or guide vanes.

The center divider 2400 may include a first guide ridge 2406 disposed on a first side of the center divider 2400 and second guide ridge 2408 disposed on an opposing second side of the center divider 2400. The first guide ridge 2406 and the second guide ridge 2408 are configured to be engaged with corresponding guide channels on the inside surfaces of the cooking appliance to convert the cooking appliance 2100 to a two-chamber configuration. The second ridge 2408 may have a keyed portion 2410 that has a first height that is greater than a second height of a remainder of the second ridge 2408. In an embodiment, the second height of the second ridge 2408 may be same as a third height of the first ridge 2406. The keyed portion 2410 of the second ridge 2408 is configured to engage with a sliding member of the cooking appliance 2100 to enable the two-chamber configuration as explained below. In addition, the different structure of the first ridge 2406 and the second ridge 2408 prevents the center divider 2400 from being installed incorrectly into the cooking appliance 2100 as the center divider 2400 can only be installed in a single direction/manner due to the presence of the keyed portion 2410.

FIGS. 26C-26E illustrate various views of the center divider 2400 according to the principles of the present disclosure. The center divider 2400 may include a first surface 2412 and an opposing second surface 2414. A first set of accessory support structures 2416 and a second set of accessory support structures 2418 may be disposed on the first surface 2412. In an embodiment, the first set of accessory support structures 2416 and the second set of accessory support structures 2418 may be formed within the first surface 2412 or attached to the first surface 2412. The first set of accessory support structures 2416 and the second set of accessory support structures 2418 are configured to support an accessory that may be placed within the cooking appliance 2100. A third set of accessory support structures 2420 and a fourth set of accessory support structures 2422 may be disposed on the second surface 2414 of the center divider 2400. The air flow channel 2404 is also disposed along the second surface 2414. In an embodiment, the air flow channel 2404 is formed such that it at least partially extends between the third set of accessory support structures 2420 and the fourth set of accessory support structures 2422. In an embodiment, the first set of accessor support structures 2416 and the second set of accessory support structures 2418 have a first length. The third set of accessory support structures 2420 and the fourth set of accessory support structures 2422 may have a second length that is smaller than the first length. In an embodiment, third set of accessory support structures 2420 and the fourth set of accessory support structures 2422 extend between a first side of the center divider 2400 that has the portion 2410 and toward the air flow channel 2404.

FIG. 26F illustrates details of how the center divider 2400 mates with a back surface 2426 of the cooking appliance 2100 in accordance with the embodiments of the present disclosure. As explained above, the second ridge 2408 and the first ridge 2406 are not same. The second ridge 2408 includes a keyed portion 2410. This ensures that the divider 2400 can only be installed in a specific orientation. The back surface 2426 of the cooking chamber of the cooking appliance 2100 may include an opening 2424. The air flow director and the fan (not shown) are positioned behind the back surface 2426. During operation, the air flow director may be operated such that it directs airflow through the opening 2424 and into the cooking chamber. When installed, the airflow channel 2404 of the divider 2400 is aligned with the opening 2424 such that any air being directed through the opening 2424 can flow into the air flow channel 2404 and be circulated within the cooking chamber. The length of the opening 2424 is designed to be substantially aligned with airflow channel 2404 such that there is minimal air leakage when the air is directed via the opening 2424. This ensures that most of the air being directed by the airflow director is routed via the airflow channel 2404.

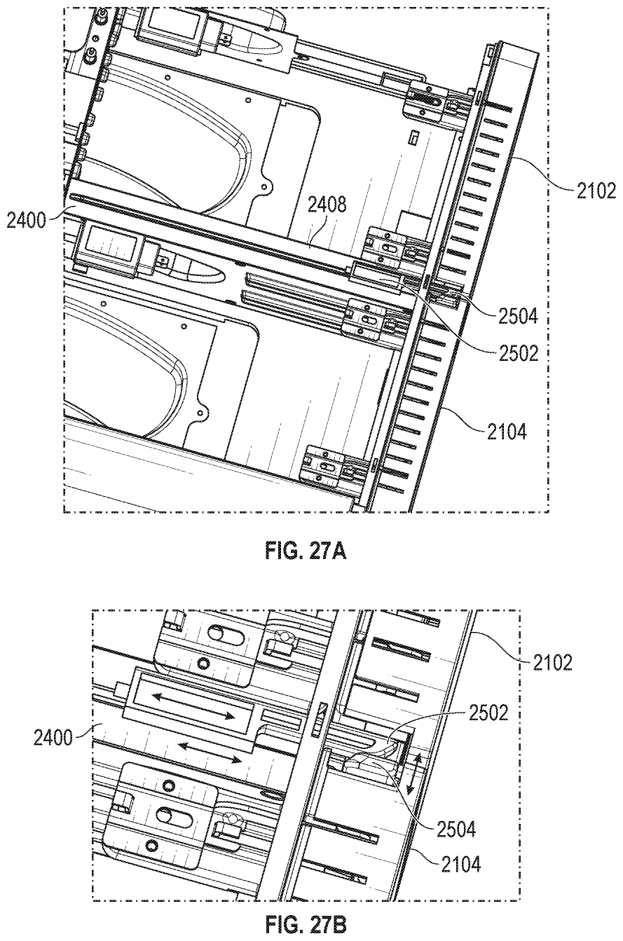

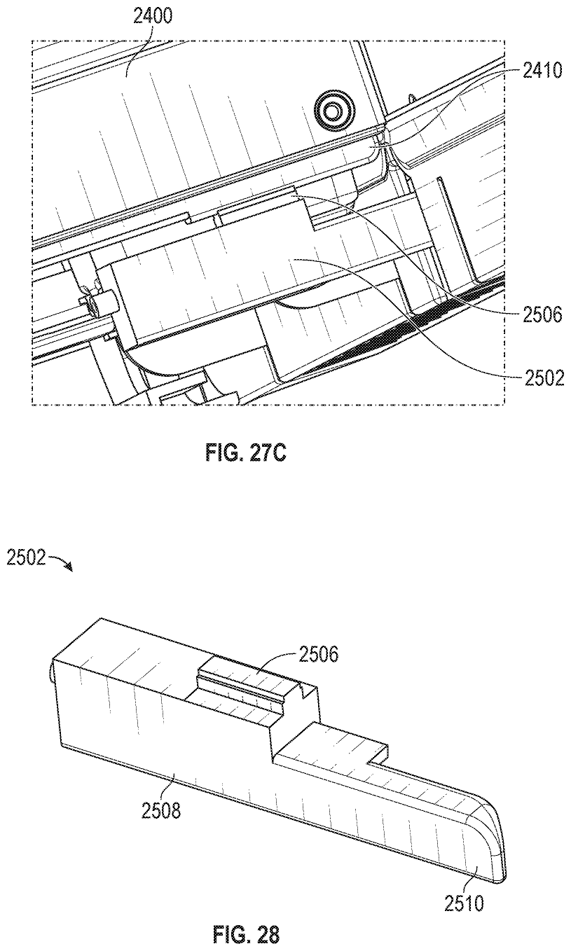

As explained above, the use of the center divider 2400 allows the cooking appliance 2100 to be used in a two-chamber configuration and removing the center divider 2400 enables the cooking appliance 2100 to be used in a single chamber configuration. In the two-chamber configuration, each of the doors 2102 and 2104 can be operated independently. In the single chamber configuration both the doors 2102 and 2104 are locked together to operate as a single door. FIGS. 27A-C show details of various portions of the cooking appliance 2100 to illustrate the door locking/unlocking assembly in accordance with the principles of the present disclosure. The door locking/unlocking assembly may include a sliding member 2502 that is mounted to the housing of the cooking appliance 2100. The sliding member 2502 may be spring loaded and translatable in a horizontal direction as illustrated by the dual-sided arrow in FIG. 27B. The sliding member 2502 may include a first portion 2508 and a second elongated portion 2510, as illustrated in FIG. 28. The first portion 2508 may be thicker than the second elongated portion 2510. The first portion 2508 may have a raised portion 2506 that is located over a top surface of the sliding member 2508. In operation, the portion 2410 of the second ridge 2408 of the center divider 2400 comes in physical contact with the raised portion 2506 to enable engaging or disengaging of the door lock.

The door locking/unlocking mechanism may further include a latch member 2504 placed in between the first door 2102 and the second door 2104 of the cooking appliance 2100. The latch member 2504 is movable in a vertical direction between a first position and a second position, as illustrated by the dual headed arrow in FIG. 27B. In the first position the latch member operates to disengage the first door 2102 from the second door 2104 such that the two doors may operate independently. In the second position, the latch member 2504 operates to cause the first door 2102 from the second door 2104 to operate as a single door by binding the two doors together. When the center divider 2400 is not being used, (i.e., the cooking appliance 2100 is used in the single chamber configuration) the sliding member 2502 is biased in a forward direction by the associated spring (not shown) as illustrated in FIG. 27B. This causes the latch member 2504 to be placed in the first position by pressing the latch member 2504 and an associated interlock in a downward direction. In this instance, the latch member 2504 and the interlock engages with the first door 2102 and the second door 2104 binding the two doors together and two doors 2102 and 2104 can now operate as a single door.

When the center divider 2400 is inserted/placed in the cooking appliance, the portion 2410 of the second ridge 2408 of the center divider 2400 physically engages with the raised portion 2506 of the sliding member 2502, as illustrated in FIG. 27C. This causes the sliding member 2502 to move backwards and the elongated portion 2510 disengages from the latch member 2504. This causes the latch member 2504 to move into the second position thereby disengaging the first door 2102 from the second door 2104. Thereafter the first door 2102 and the second door 2104 can operate independently from each other and the appliance 2100 is now placed in the two chamber configuration. The door locking/unlocking mechanism may also include a microswitch (not shown) that is activated when the center divider 2400 is installed in the cooking appliance 2100. The microswitch sends a signal to the main control board of the cooking appliance indicating that the cooking appliance is now in a two chamber configuration. The control board may then perform one or more actions to enable the cooking appliance to be used in a two chamber configuration. Similarly, when the center divider 2400 is removed from the appliance 2100, the same microswitch sends another signal to the main control board causing the main control board to perform one or more other actions to enable the cooking appliance 2100 to be used in the single chamber configuration.

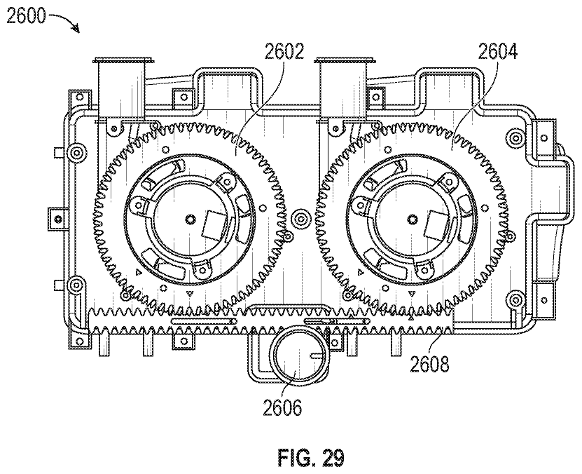

As explained above, when the cooking appliance is moved between the horizontal and the vertical orientation, the air flow director is rotated (or otherwise actuated) accordingly to direct the air flow through the appropriate air flow channel. FIG. 29 illustrates a schematic of different mechanism to effect the rotation of the air flow director according to another embodiment of the present disclosure. In this embodiment, the air flow control system may have a first gear wheel 2602 and a second gear wheel 2604. The first gear wheel 2602 may be coupled to a first air flow director (not shown) and the second gear wheel may be coupled to a second air flow director (not shown). The air flow control mechanism may further include a linear gear member 2608 that is coupled to each of the first gear wheel 2602, the second gear wheel 2604, and a motor 2606. When the cooking appliance is placed in the horizontal or the vertical orientation, a sensor detects the change in orientation and sends a signal to a motor control board. The motor control board causes the motor to rotate in the appropriate direction and by an appropriate amount. This causes the linear gear member 2608 to translate in a transverse direction causing the first gear wheel 2602 and the second gear wheel 2604 to rotate in sync. This causes the corresponding air flow directors/baffles to rotate thereby directing the air flow to the selected air flow channel.

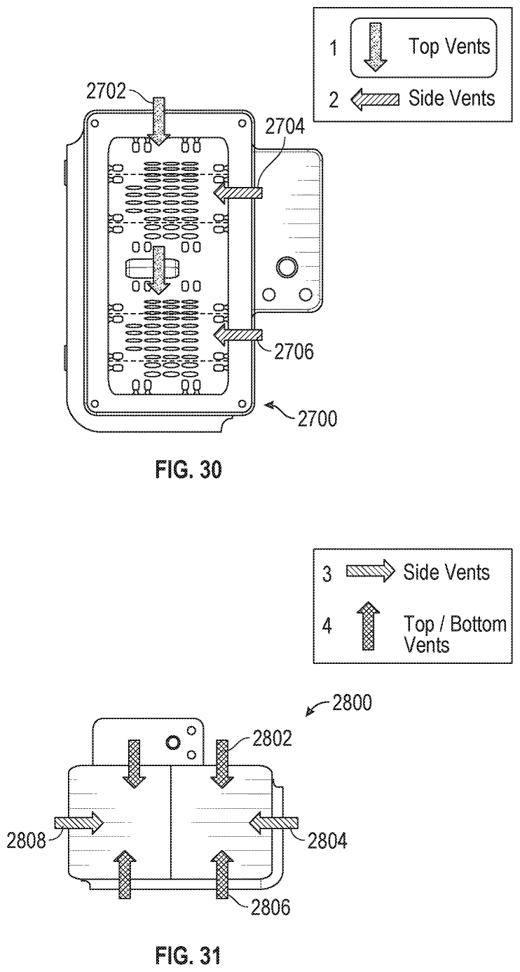

As noted above, the cooking appliance may have two air flow channels on the top, a third airflow channel on one side, and fourth airflow channel embedded in the center divider 2400. FIG. 30 illustrates a schematic of a cooking appliance according to another embodiment of the present disclosure. The embodiment of FIG. 30 illustrates a cooking appliance 2700 being used in a vertical orientation and in a two chamber configuration. In this instance, the cooking appliance 2700 may include a first air flow channel 2702 located at a top of the cooking appliance 2700, a second air flow channel that is part of the center divider (not shown), a third air flow channel 2704 that is located at a right side of the cooking appliance and a fourth air flow channel 2706 also located on the right side of the cooking appliance. In this instance, all four air flow channels may be active, and the air flow control mechanism may be operable to move the air flow director(s) to selectively direct the air flow to either of the four air flow channels during a cooking cycle. For example, during a first part of a cooking cycle, the air flow may be directed to the first air flow channel 2702 and the second air flow channel. During a second part of the cooking cycle, the air flow directors may be rotated such that the air flow is directed to the third air flow channel 2704 and the fourth air flow channel 2706. In other instances, a first air flow director may be operated to direct air flow to the first air flow channel 2702 and the second air flow director may be operated to direct air flow to the fourth air flow channel 2706.

FIG. 31 illustrates a schematic of a cooking appliance 2800 according to yet another embodiment of the present disclosure. The cooking appliance 2800 is shown in a horizontal orientation. In this embodiment, the cooking appliance 2800 may have a first pair of air flow channels 2802 located on a first side of the cooking appliance 2800, a second air flow channel 2804 located on a second side of the cooking appliance 2800, a third pair of air flow channels 2806 located on a third side of the cooking appliance 2800, and a fourth air flow channel 2808 located on a fourth side of the cooking appliance 2800. The first side may be orthogonal to the second side, parallel to the third side, and orthogonal to the fourth side. The second side may be orthogonal to the first side and the third side and parallel to the fourth side. The third side may be orthogonal to the second side and the fourth side and parallel to the first side. The fourth side may be orthogonal to the first side and the third side and parallel to the second side. In this embodiment, the individual air flow directors may be operated to direct airflow to any of the air flow channels 2802-2808 depending on the cooking requirements. For example, when the cooking appliance is placed in the horizontal orientation, only the set of air flow channels 2802 and/or the set of air flow channels 2806 may be used to control airflow within the respective chamber of the cooking appliance depending on the cooking recipe and/or the type of food being cooked. In another instance, if the cooking appliance 2800 is placed in a vertical orientation, only the air flow channels 2808 and/or 2804 may be used to control air flow within the cooking appliance 2800 depending on the recipe and/or the type of food being cooked. In other embodiments, a cooking mode may cause one or more of the air flow channels 2802-2808 be selectively used to control flow of air within the respective chamber of the cooking appliance 2800.

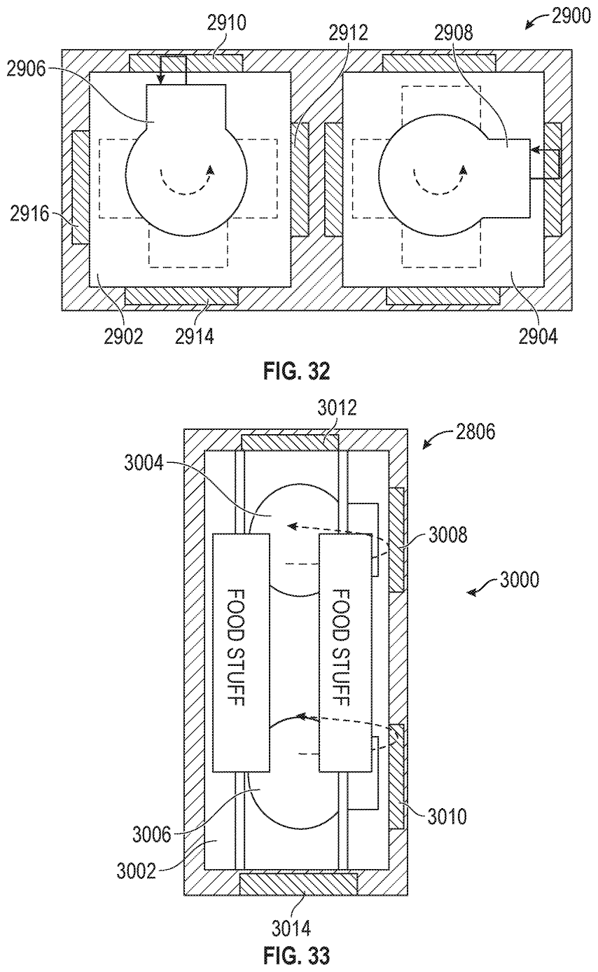

FIG. 32 illustrates a schematic of a cooking appliance 2900 according to yet another embodiment of the present disclosure. The cooking appliance 2900 is being shown in a horizontal orientation. In this instance, the cooking appliance 2900 can include a first chamber 2902 and a second chamber 2904. The first chamber 2902 may have an associated first air flow director 2906 that can be controlled to direct airflow within the first chamber 2902. The second chamber 2904 may have an associated second air flow director 2908 that can be controlled to direct airflow within the second chamber 2904. The first chamber 2902 may have four airflow channels 2910, 2912, 214, and 2916 each located at one side of the first chamber 2902 thereby providing air flow control via all four sides of the first chamber 2902. The first air flow director 2906 can be placed in any of the four positions shown by the dotted lines. Based on the position of the first air flow director 2906, it can direct airflow to any of the four air flow channels 2910-2916. Similarly, the second chamber 2904 may also include four air flow channels and the second air flow director 2908 may be operated to direct air flow to any of the four channels of the second chamber 2904. In an embodiment, the first air flow director 2906 and the second air flow director 2908 may be operated independently so that two different cooking cycles may proceed concurrently in the two chambers. In other embodiments, the first air flow director 2906 and the second air flow director 2908 may be operated in sync, especially when the cooking appliance 2900 is being used in a single chamber configuration. In an embodiment, during a cooking cycle, the first air flow director 2906 and/or the second air flow director 2908 may be operated to direct air flow towards one or more of the respective air flow channels. For example, during a first time period of the cooking cycle, the first air flow director 2906 may be operated to direct air flow toward the air flow channel 2910. Then, during a second time period of the cooking cycle, the first air flow director 2906 may be operated to direct air flow to the air flow channel 2916. During a third time period of the cooking cycle the first air flow director 2906 may be operated to direct air flow to the air flow channel 2912 and during a fourth time period of the cooking cycle the first air flow director 2906 may be operated to direct air flow to the air flow channel 2914. In some embodiments, the sequence of selecting the air flow channels to direct the air to, the timing of operating the first air flow director 2906, the duration for which to maintain air flow within each of the air flow channels may be varied dynamically. The dynamic variation can be based one or more factors including, but not limited to, type of food being cooked, a cooking mode, a function selected by a user, a cooking recipe, etc. Thus, the air flow director may be operated in a programmable or adaptive manner to optimize the cooking performance for different types of food and/or cooking modes or recipes.

As noted above, the multiple air flow directors of the cooking appliance may be operated independently or in sync with each other. In other embodiments, the air flow directors may be placed in different positions during a cooking cycle to direct and control airflow within the cooking appliance based on the type of food being cooked and the cooking recipe. FIG. 33 illustrates an example of a cooking appliance 3000 being used in a vertical orientation in a single chamber configuration according to an embodiment of the present disclosure. The cooking appliance 3000 may be configured to operate as a single chamber 3002. The cooking appliance 3000 may further include a first air flow director 3004 and a second air flow director 3006. The cooking appliance may further include a first airflow channel 3008, a second airflow channel 3010, a third airflow channel 3012, and a fourth airflow channel 3014. Consider that food that is attached to one or more skewers is being cooked. In this instance, in order to cook the food evenly along the length of the skewer, air flow may need to be controlled such that the air wraps around the food in an even manner as shown by the curved arrow. In this instance, during a first portion of the cooking cycle, the first air flow director 3004 may be positioned to direct air flow to the third airflow channel 3012 and the second air flow director 3006 may be positioned to direct air flow to the fourth airflow channel 3014. Thereafter, during a second portion of the cooking cycle, the cooking appliance may send a signal to the motor control board to operate the motor to rotate the first air flow director 3004 and the second air flow director 3006 such that the air flow is now directed to the second air flow channel 3008 and the third air flow channel 3010. This causes the air to flow and wrap around the food in order to evenly cook the food. In a third portion of the cooking cycle, the first air flow director 3004 and the second air flow director 3006 may again be rotated in sync or independently to direct the air flow to different air flow channels. Thus, one or both of the first air flow director 3004 and the second air flow director 3006 may be operated multiple times during a cooking cycle based on the food being cooked and the cooking recipe.

In another embodiment, the cooking appliance 3000 may be used in a horizontal orientation in a single chamber configuration. In this instance, the cooking appliance 3000 may have air flow channels on all sides as illustrated in FIG. 31. Consider that a pizza is being cooked in this instance. Based on the cooking recipe, the air flow directors may be operated multiple times during the cooking cycle and placed in multiple positions to direct the air flow to the top air flow channels, the side air flow channels, and/or the bottom air flow channels to ensure an even cooking of the pizza. Thus, even in the horizonal orientation, the air flow channels can be dynamically selected to control the air flow within the cooking appliance based on the cooking recipe being executed, the food being cooked, and the configuration of the cooking appliance.

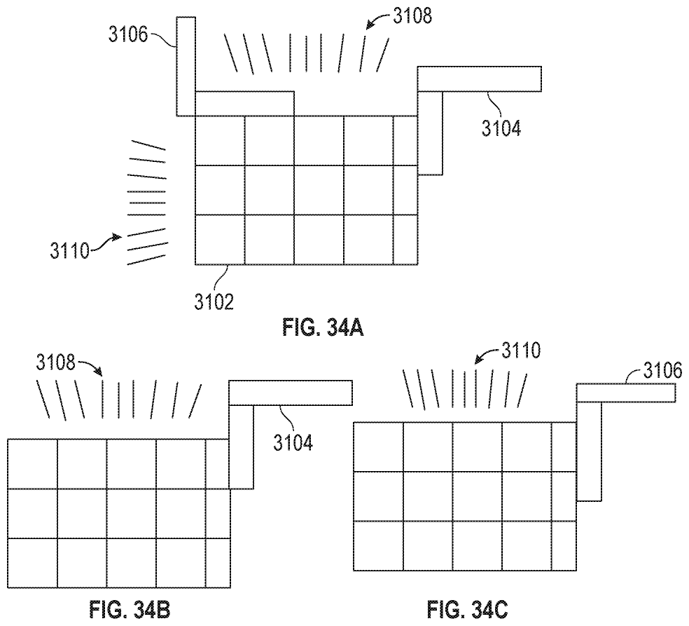

As explained above, the cooking appliance may have a control unit/display 20 or 2108 that may be used to provide control inputs to the cooking appliance. In an embodiment, the control unit/display 20/2108 may be realized using a LCD, OLED, or similar type of display technology. In other embodiments, the control unit/display 20/2108 may include one or more static icons that may be selectively illuminated based on the orientation of the cooking appliance. FIGS. 34A-34C illustrate an example of how static icons of a control unit/display 20/2108 may be selectively illuminated according to an embodiment of the present disclosure. The control unit/display 20/2108 may include a first static icon 3102 that represents a wire basket accessory that can be used in the cooking appliance, a second static icon 3104 that represents a first handle portion of the wire basket, a third static icon 3106 that represents a second handle portion of the wire basket, a fourth static icon 3108 that represents heat dissipation in a first orientation of the wire basket, and a fifth static icon 3110 that represents heat dissipation in a second orientation of the wire basket. When the cooking appliance is placed in a first orientation, the first static icon 3102, the second static icon 3104 and the fourth static icon 3108 may be illuminated, as illustrated in FIG. 34B. The third static icon 3106 and the fifth static icon 3110 are not illuminated in this orientation. When the cooking appliance is placed in the second orientation, the second static icon 3104 and the fourth static icon 3108 are not illuminated and instead, the third static icon 3106 and the fifth static icon 3110 are now illuminated, as illustrated in FIG. 34C. In this manner, one or more of the static icons may be selectively illuminated based on the orientation of the cooking appliance.

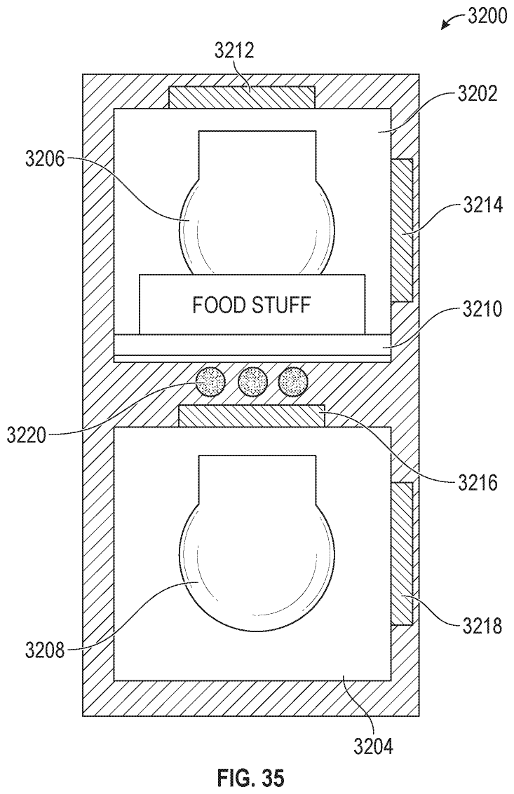

FIG. 35 is a schematic of a cooking appliance 3200 according to yet another embodiment of the present disclosure. In this embodiment, the cooking appliance 3200 is being used in a vertical orientation in a two chamber configuration. The cooking appliance 3200 defines a first chamber 3202 and a second chamber 3204 is disposed vertically below the first chamber 3202. The first chamber 3202 may have two associated air flow channels 3212 and 3214. The second chamber 3204 may have two associated air flow channels 3218 and 3216. A first air flow director 3206 may be operated to direct air flow within the first chamber 3202 and a second air flow director 3208 may be operated to direct air flow within the second chamber 3204. A removable mullion accessory 3210 may be placed within the first chamber 3204. The mullion 3210 may have its associated heating element 3220 that may provide additional heat to the mullion 3210. The heating element 3220 may be a resistive heating element, a heated coil, or the like. When the cooking appliance is used in a single chamber configuration, the removable mullion 3210 may be placed at different locations within the single chamber to create varying sizes of chambers

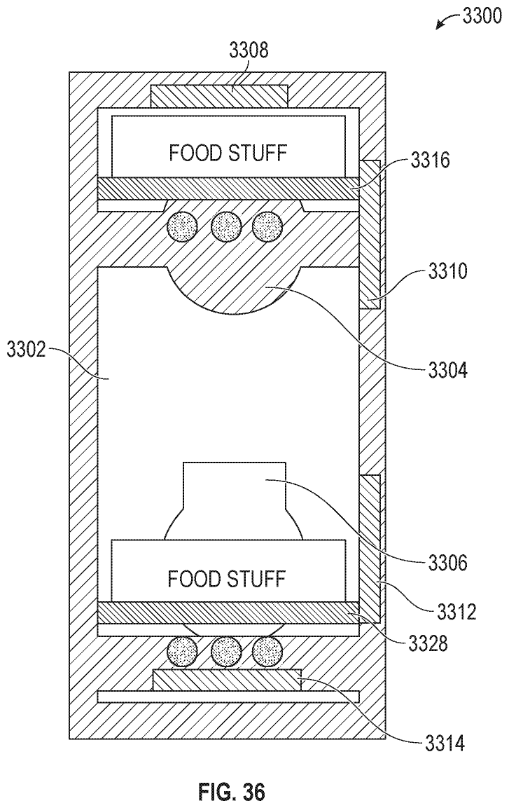

FIG. 36 illustrates a cooking appliance 3300 that includes multiple accessories according to another embodiment of the present disclosure. The cooking appliance 3300 is being used in a vertical orientation and defines a single chamber 3302. A first removable accessory 3316 and a second removable accessory 3318 may be installed within the chamber 3302. This allows cooking of two different food items in the single chamber configuration without the use of the center divider. The first accessory 3316 and the second accessory 3318 may be placed at different locations within the chamber 3302 to define multiple chambers of varying sizes depending on the space need to cook the various food items. In an embodiment, each of the first accessory 3316 and the second accessory 3318 may have its dedicated heating source. A first air flow director 3304 may be operated to selectively direct the air flow to a first air flow channel 3310 and/or a second air flow channel 3308. Similarly, a second air flow director 3306 may be operated to selectively direct the air flow to a third air flow channel 3312 and/or a fourth air flow channel 3314.

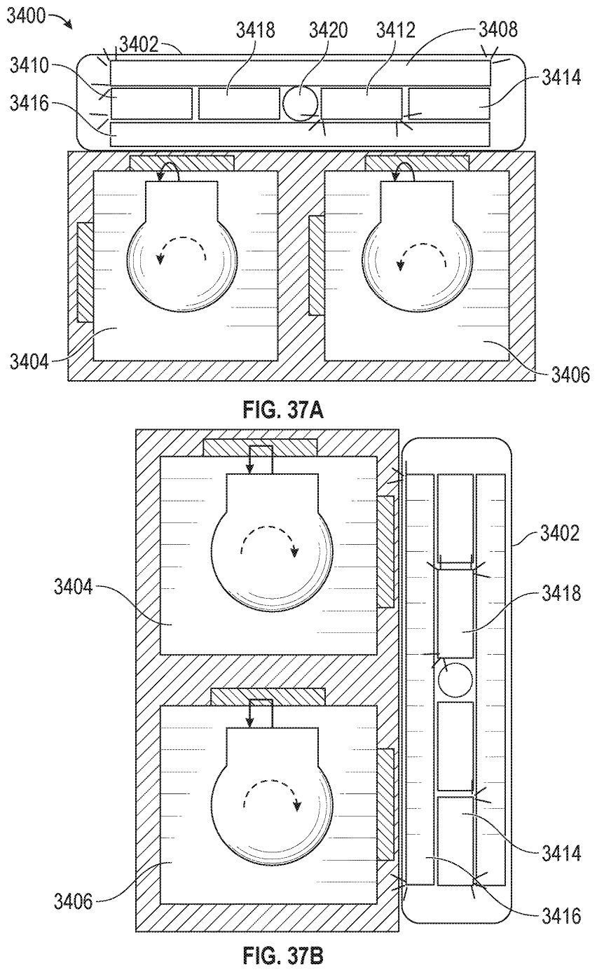

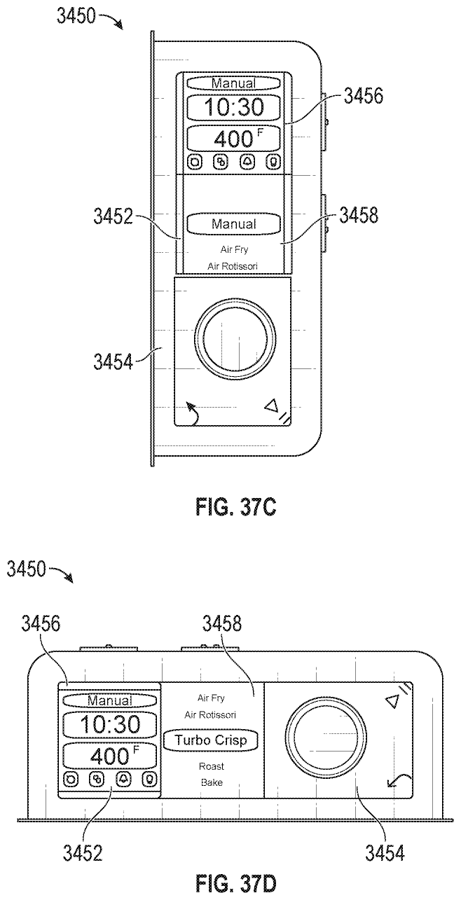

FIGS. 37A and 37B illustrate a cooking appliance 3400 in which the display is automatically configured based on the orientation of the cooking appliance according to an embodiment of the present disclosure. As noted above, the display (e.g., control unit/display 20 or 2018) is used to display information and for receiving user input to control the cooking appliance. When the cooking appliance is moved from one orientation another, the display is also automatically reconfigured such that the control unit/display us positioned appropriately to display the information in proper format. FIG. 37A illustrates an example in which the cooking appliance 3400 is placed in a horizontal orientation. The cooking appliance 3400 may include a display 3402. The display 3402 may have multiple sections defined that may be selectively used to display information based on the orientation of the cooking appliance 3400. The display 3402 may include a control input 3420 (e.g., a knob, button, or the like) that may be operated to provide select or provide input to the cooking appliance 3400. The display 3402 may include a first section/portion 3408, a second portion 3410, a third portion 3418, a fourth portion 3412, a fifth portion 3414, and sixth portion 3416. It is to be noted that the illustrated portions are exemplary and one skilled in the art will realize that the display 3402 may be configured to define more or less portions that what are illustrated in FIG. 37A and FIG. 37B.

When the cooking appliance 3400 is placed in the horizontal orientation, the first portion 3408, the second portion 3410, and the third portion 3412 may be activated to display information related to the cooking appliance 3400. For instance, the first portion 3408 may display information of the cooking appliance 3400 when the cooking appliance is used in a single chamber configuration. When the cooking appliance 3400 is used in a two chamber configuration, the second portion 3410 may display information and accept user input associated only with the first chamber 3404 and the fourth portion 3412 may display information and accept user input associated only with the second chamber 3406. When the cooking appliance is placed in vertical orientation, as illustrated in FIG. 37B, the first portion 3408, the second portion 3410, and the third portion 3412 may be deactivated and the third portion 3418, the fifth portion 3414, and sixth portion 3416 may be activated. In an embodiment, the sixth portion 3416 may be used to display information about the cooking appliance 3400 when the cooking appliance is used in a single chamber configuration. When the cooking appliance 3400 is used in a two chamber configuration, the third portion 3418 may be used to display information and/or accept user input associated only with the first chamber 3404 and the fifth portion 3414 may be used to display information and/or accept user input associated only with the first chamber 3406. In this manner the display 3402 is dynamically reconfigured and information display is automatically reformatted based on the orientation of the cooking appliance. In an embodiment, a sensor (e.g., a gyroscope, accelerometer, etc.) included in the display 3402 may detect the change in orientation of the cooking appliance 3400.

FIGS. 37C and 37D illustrate another embodiment where a display/control unit 3450 is automatically recognized based on the orientation of the cooking appliance. In this instance, FIG. 37C illustrates the configuration of the control unit 3450 when the cooking appliance is placed in a vertical orientation. In this instance, a display portion 3452 of the control unit 3450 is located vertically above a control input 3454. The information displayed in the display portion 3452 is formatted and arranged in a first orientation as illustrated to make it easier to read. When the cooking appliance is placed in the horizontal orientation, the information displayed in display portion 3452 is automatically reformatted and rearranged in a second orientation as illustrated in FIG. 37D. For instance, in the vertical orientation, the displayed information 3456 is placed vertically adjacent to and above the selectable options 3458, while in the horizontal orientation, the displayed information 3456 is placed horizontally adjacent to the selectable options 3458 in order to make optimal use of the display portion 3452 in both orientations.

In some embodiments, the display/control unit 3402 may be physically decouplable from the cooking appliance 3400. In this embodiment, the control unit 3402 may be used as a remote control to operate the cooking appliance 3400. The control unit 3402 may communicate with the cooking appliance using any known wireless communication protocol suitable for the purpose. In other embodiments, a single control unit 3402 may control multiple cooking appliances. Initially, the control unit 3402 may be paired with multiple cooking appliances. During operation, a user may select one of the paired cooking appliances to control. Based on the selection, the control unit 3402 may then the data to the appropriate cooking appliance. In one embodiment, the control unit 3402 may identify the multiple cooking appliances using a unique identification information such as a MAC address of the cooking appliance. The MAC address may be stored in association with a selected/given name for the cooking appliance. When the user selects a particular cooking appliance to control, the control unit 3402 sends the data to appropriate cooking appliance based on the associated MAC address.

In some embodiments, the control unit 3402 may support voice-based input to control the associated cooking appliance. In this embodiment, the control unit 3402 may include a low-power microcontroller or system-on-chip (SoC) capable of running speech recognition algorithms locally or streaming audio to a cloud-based engine. A built-in microphone array with acoustic echo cancellation and noise suppression may enable clear audio capture, while a dedicated digital signal processor (DSP) or neural processing unit (NPU) may accelerate keyword detection and natural language parsing. The control unit 3402 may use a far-field microphone array with beamforming, acoustic echo cancellation, and noise suppression to capture user speech. The DSP or low-power microcontroller may handle initial preprocessing such as gain control and keyword (“wake word”) detection. The received audio/voice input may be digitized and either processed locally or sent securely to a cloud-based automatic speech recognition (ASR) engine. The ASR converts spoken words to text, which is then processed by a natural language understanding (NLU) engine. The NLU uses trained models (e.g., deep neural networks) to extract intent, entities, and contextual parameters from the text. Based on the detected intent and other parameters, a message may be sent to the cooking appliance to control/operate the appropriate feature.

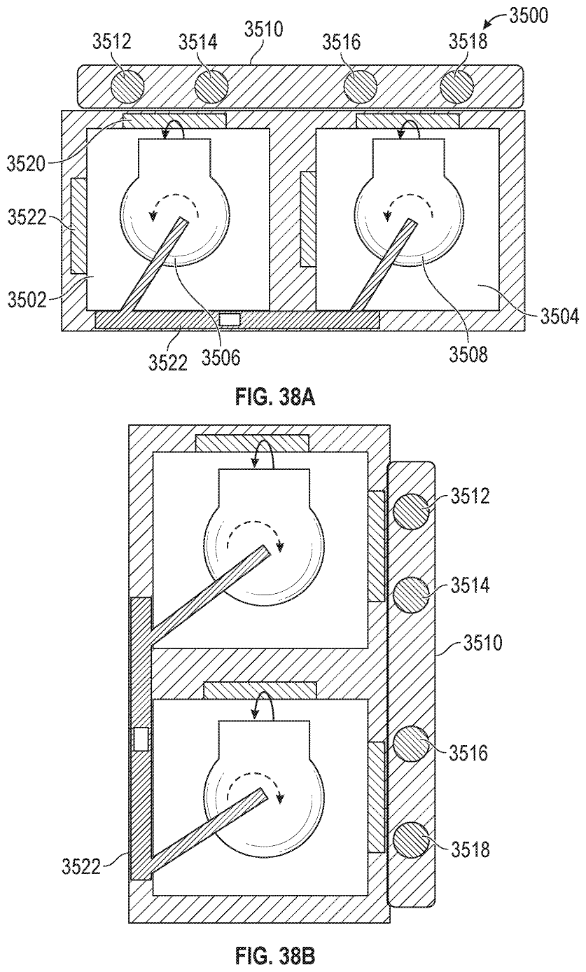

FIGS. 38A and 38B illustrate a cooking appliance 3500 according to an embodiment of the present disclosure. The cooking appliance may define a first chamber 3502 and a second chamber 3504 when being used in a two chamber configuration. A first air flow director 3506, a first air flow channel 3520, and a second air flow channel 3522 may in conjunction with each other direct air flow within the first chamber 3502. A second air flow director 3508, a third air flow channel, and a fourth airflow channel may in conjunction with each other direct air flow within the first chamber 3504. The cooking appliance 3500 may include a control unit 3510 that may be used to provide inputs to the cooking appliance. The control unit 3510 may include a first control input device 3512 and a second control unit device 3514 that may be used to provide control the feature associated with the first chamber 3502. The control unit 3510 may further include a third control input device 3516 and a fourth control input device 3518 that may be used to control the features associated with the second chamber 3504. In an embodiment, the first control input device 3512 and third control input device 3516 may be used to provide a temperature setting for the respective chambers. The first control input device 3512 and third control input device 3516 may be operatively coupled to a thermostat that may regulate the temperature within the respective chamber based on the setting provided via the first control input device 3512 and third control input device 3516. In an embodiment, the second control unit device 3514 and the fourth control input device 3518 may be operatively coupled to a timer associated with the respective chamber. The second control unit device 3514 and the fourth control input device 3518 may be operated to provide a timing input to the timer. For example, actuating the second control unit device 3514 and/or the fourth control input device 3518 may wind a mainspring that stores potential energy and may also align a cam or a gear train with the desired time setting. A spring coupled to the gear train regulates the speed of unwinding (i.e., counting down). At the end of the timing cycle, the cam or lever mechanically actuates a switch or releases a latch thereby opening/closing an electrical circuit that powers off the cooking appliance.

The cooking appliance 3500 may also include a mechanical sliding mechanism 3522 that is physically coupled to each of the first air flow director 3506 and the second air flow director 3508. The sliding mechanism 3522 may be operated manually or automatically to move the first and the second air flow directors 3506 and 3508 to control the air flow direction within the respective chambers. In an embodiment, the mechanical sliding assembly may be operated from outside the cooking appliance 3500.

The various air flow direction control features described above can work in conjunction with each other or may be mutually exclusive to each other. The choice of which airflow control features are used may depend on one or more of: the orientation of the cooking appliance, a cooking mode of the cooking appliance, the type of food being cooked, the recipe being used, and/or whether an accessory is being used and if so, which specific accessory is being used. In some embodiments, multiple air flow control features, described above, may be used concurrently to manage the flow of air within the cooking appliance in conjunction with one or more convective heating and fan control systems of the cooking appliance. The various air flow control features may be integrated within the housing of the cooking appliance or integrated with the accessory usable with the cooking appliance or attached to the cooking appliance.

One or more illustrative embodiments of the disclosure have been described above. The above-described embodiments are merely illustrative of the scope of this disclosure and are not intended to be limiting in any way. Accordingly, variations, modifications, and equivalents of the embodiments disclosed herein are also within the scope of this disclosure.

While the present disclosure has been described with reference to a number of embodiments, it will be understood by those skilled in the art that the invention is not limited to such disclosed embodiments. Rather, the disclosure can be modified to incorporate any number of variations, alterations, substitutions, or equivalent arrangements not described herein, but which are commensurate with the spirit and scope of the disclosure. Additionally, while various embodiments of the disclosure have been described, it is to be understood that aspects of the disclosure may include only some of the described embodiments. Accordingly, the disclosure is not to be seen as limited by the foregoing description but is only limited by the scope of the appended claims.

What is claimed is:

1. A cooking appliance comprising:
a housing defining a chamber, the chamber having a first surface, a second surface, a third surface and a fourth surface;
a first set of supports disposed on the first surface;
a second set of supports disposed on the second surface;
a third set of supports disposed on the third surface; and
a fourth set of supports disposed on the fourth surface, wherein the first surface is orthogonal to the second surface, the second surface is orthogonal to the third surface, and the third surface is orthogonal to the fourth surface.

2. The cooking appliance of claim 1, further comprising:
a plurality of heating elements; and
a plurality of air flow control systems, each of the plurality of airflow control systems including:
a fan;
a sensor configured to detect an orientation of the cooking appliance;
an air flow director coupled to the fan; and
a motor coupled to the air flow director.

3. The cooking appliance of claim 2, wherein the air flow director is operable to control the flow of air within the cooking appliance.

4. The cooking appliance of claim 2, wherein the motor is configured to:
receive an input from the sensor; and
operate the air flow director based on the input.

5. The cooking appliance of claim 1, further comprising:
a processor;
one or more sensors coupled to the processor; and
a display device coupled to the processor, wherein the processor is operable to:
receive an input from the one or more sensors;
determine an orientation of the cooking appliance based on the input; and
enable a first set of cooking modes based on the orientation.

6. The cooking appliance of claim 1, wherein the cooking appliance can be configured in a first orientation and a second orientation, wherein:
in the first orientation, a first set of cooking modes are enabled while a second set of cooking modes are disabled; and
in the second orientation, the second set of cooking modes are enabled while the first set of cooking modes are disabled.

7. The cooking appliance of claim 1, further comprising a support feature having a first portion that is disposed over a first external surface of the housing and a second portion that is disposed over a second external surface of the housing, wherein the first external surface is orthogonal to the second external surface.

8. The cooking appliance of claim 1 further comprising a plurality of doors, wherein the plurality of doors are combinable to operate as a single door.

9. The cooking appliance of claim 8, wherein each of the plurality of doors is moveable about a plurality of axes.

10. The cooking appliance of claim 1, wherein the first surface is opposite to the third surface and the second surface is opposite to the fourth surface and wherein the first set of supports are identical to the third set of supports and second set of supports are identical to the fourth set of supports.

11. The cooking appliance of claim 1, further comprising a first set of accessories and a second set of accessories, and wherein:
the first set of accessories is configured for use when the cooking appliance is placed in a first orientation; and
the second set of accessories is configured for use when the cooking appliance is placed in a second orientation.

12. A method of operating a cooking appliance, the method comprising:
receiving, by a processor of the cooking appliance at a first time, first data from one or more sensors of the cooking appliance;
determining, by the processor based on the first data, that the cooking appliance is in a first orientation of a plurality of orientations;
determining, by the processor, a first set of cooking modes based on the first orientation;
displaying, by the processor on a display of the cooking appliance, the first set of cooking modes;
receiving an input indicative of selection of a first cooking mode from the first set of cooking modes; and
operating the cooking appliance based on the first cooking mode.

13. The method of claim 12, further comprising:
receiving, by the processor at a second time, second data from the one or more sensors;
determining, by the processor based on the second data, that the cooking appliance is in a second orientation of the plurality of orientations;
determining a second set of cooking modes associated with the second orientation;
enabling the second set of cooking modes; and
disabling the first set of cooking modes.

14. The method of claim 13, wherein the first orientation is a horizontal orientation and the second orientation is a vertical orientation.

15. The method of claim 13, further comprising:
displaying first content in a first format when the cooking appliance is in the first orientation; and
displaying second content in a second format when the cooking appliance is in the second orientation.

16. A cooking appliance comprising:
a heating system;
an airflow control system;
a housing that defines a chamber;
a plurality of air flow channels; and
a plurality of doors coupled to the housing, wherein:
the chamber includes four surfaces and each of the four surfaces has a plurality of supports disposed thereon, each of the plurality of supports on each of the four surfaces configured to accept a removable accessory; and
the airflow control system includes a rotating air flow director configured to selectively block one or more of the plurality of air flow channels.

17. The cooking appliance of claim 16, further comprising:
a first powered accessory, wherein the powered accessory is configured to be supported by a first pair of supports of the plurality of supports and wherein the first powered accessory receives electrical power from the cooking appliance.

18. The cooking appliance of claim 16, wherein the plurality of supports comprises:
a first set of supports disposed on a first surface;
a second set of supports disposed on a second surface;
a third set of supports disposed on a third surface; and
a fourth set of supports disposed on a fourth surface, wherein:
the first surface is orthogonal to the second surface;
the second surface is orthogonal to the third surface; and
the third surface is orthogonal to the fourth surface.

19. The cooking appliance of claim 16, further comprising support feature coupled to two or more external surfaces of the housing.

20. The cooking appliance of claim 16, wherein the cooking appliance is operable in a first orientation and a second orientation that is orthogonal to the first orientation, the cooking appliance further comprising a display device coupled to the housing, wherein the cooking appliance is configured to:
in the first orientation:
enable a first set of cooking modes; and
receive a first input, via the display device, associated with the first set of cooking modes; and
in the second orientation:
enable a second set of cooking modes;
disable the first set of cooking modes; and
receive a second input, via the display device, associated with the second set of cooking modes.

21. The cooking appliance of claim 16, wherein the airflow control system includes two or more fans, wherein the two or more fans are individually controllable.

22. A cooking appliance comprising:
a cooking chamber having a plurality of airflow channels defined within the cooking chamber; and
an air flow director configured to selectively direct airflow along one or more of the plurality of airflow channels based on an orientation of the cooking appliance.

23. The cooking appliance of claim 20, wherein the cooking appliance is operable in a first orientation and a second orientation and wherein the first orientation is orthogonal to the second orientation.

24. The cooking appliance of claim 23, wherein the plurality of air flow channels include a first airflow channel and a second airflow channel and wherein:
in the first orientation, the airflow director directs the airflow toward the first airflow channel; and
in the second orientation, the airflow director directs the airflow toward the second airflow channel.

25. The cooking appliance of claim 22, wherein the plurality of airflow channels are defined within an interior surface of the cooking chamber.

26. The cooking appliance of claim 22, further comprising a fan and a heating element.

27. The cooking appliance of claim 26, wherein the fan and the heating element are located towards a rear end of the cooking appliance.

28. The cooking appliance of claim 22, wherein the cooking chamber includes a first chamber and a second chamber.

29. The cooking appliance of claim 28, wherein the first chamber is positioned adjacent to the second chamber, and the cooking appliance further comprises a divider, the divider being configured to be placed between the first chamber and the second chamber.

30. The cooking appliance of claim 29, wherein the divider is removably couplable to the cooking appliance.

31. The cooking appliance of claim 22, wherein the airflow director is further configured to selectively direct the airflow along the one or more of the plurality of airflow channels based on a configuration of the cooking appliance.

32. The cooking appliance of claim 31, wherein the configuration includes selection of a cooking recipe or selection of a type of food being cooked.

33. A method comprising, by a cooking appliance:
determining an orientation of the cooking appliance;
selecting one or more of a plurality of airflow channels of the cooking appliance; and
operating an airflow director to direct airflow toward the selected one or more airflow channels.

34. The method of claim 33, further comprising:
detecting selection of a cooking recipe; and
operating the airflow director further based on the cooking recipe.

35. The method of claim 33, wherein the orientation includes a first orientation and a second orientation, and the plurality of airflow channels include a first airflow channel and a second airflow channel, the method further comprising:
detecting, at a first time, that the cooking appliance is placed in the first orientation; and
operating the airflow director to direct airflow toward the first airflow channel.

36. The method of claim 35, further comprising:
detecting, at a second time, that the cooking appliance is placed in the second orientation; and
operating the airflow director to direct airflow toward the second airflow channel.

37. The method of claim 33, wherein operating the airflow director is further based on a cooking mode of the cooking appliance.

38. The method of claim 33, wherein the airflow director is coupled to a motor, the method further comprising:
receiving data from a sensor of the cooking appliance;
determining the orientation of the cooking appliance based on the data; and
operating the motor based on the data.

39. A cooking appliance comprising:
one or more cooking chambers;
one or more airflow directors in fluid communication with the one or more cooking chambers; and
one or more airflow channels in fluid communication with the one or more airflow channels directors.

40. The cooking appliance of claim 39, further comprising:
a fan;
a motor coupled to the fan; and
a heating element coupled to the fan, wherein the motor is configured to operate the fan based on an orientation of the cooking chamber and the one or more airflow directors are configured to selectively direct airflow from the fan to the one or more airflow channels.

41. The cooking appliance of claim 39, wherein:
the one or more cooking chambers include a first cooking chamber and a second cooking chamber;
the one or more airflow directors include a first airflow director associated with the first cooking chamber and a second airflow director associated with the second cooking chamber;
the one or more airflow channels include a first airflow channel and a second airflow channel;
the cooking appliance is configured to operate in a first orientation and a second orientation; and
in the first orientation, the first airflow director is configured to direct airflow toward the first airflow channel, and the second airflow director is configured to direct the airflow toward the second airflow channel.
